(19) United States
(12) Patent Application Publication
(10) Pub. No.: US 2010/0006774 A1
(43) Pub. Date: Jan. 14, 2010

(54) DETECTION METHOD, DETECTION APPARATUS, AND SAMPLE CELL AND KIT FOR DETECTION

(75) Inventors: Hisashi OHTSUKA, Ashigarakami-gun (JP); Kazuyoshi HORII, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/501,906

(22) Filed: Jul. 13, 2009

(30) Foreign Application Priority Data
Jul. 14, 2008 (JP) 2008-182226

(51) Int. Cl. G01N 21/64; G01N 21/05

(52) U.S. Cl. 250/459.1; 250/458.1; 356/246; 250/227.11

(57) ABSTRACT

A sensor chip including a sensor portion that has at least a metal layer deposited on a surface of a dielectric plate is used. A fluorescent-label binding-substance in an amount corresponding to the amount of a detection target substance in a liquid sample binds onto the sensor-portion. The amount of the detection target substance is detected based on the amount of light generated by excitation of a fluorescent label in the fluorescent-label binding substance. An electrified fluorescent substance containing a plurality of fluorescent dye molecules enclosed by a material that transmits fluorescence output from the plurality of fluorescent dye molecules is used as the fluorescent label. The electrified fluorescent substance is attracted to the sensor portion by applying voltage to the liquid sample in a state in which the fluorescent-label binding substance has bound to the sensor portion. In this state, the amount of the detection target substance is detected.

### BACKGROUND OF THE INVENTION

1. Field of the Invention

The present invention relates to a detection method, a detection apparatus, a sample cell for detection and a kit for detection to detect a substance to be detected (a detection target substance) in a sample.

2. Description of the Related Art

Conventionally, in the field of bio-measurement and the like, a fluorescence detection method is widely used as a highly accurate and easy measurement method. In the fluorescence detection method, a sample that is presumed to contain a detection target substance that outputs fluorescence by being excited by irradiation with light having a specific wavelength is irradiated with excitation light having the specific wavelength. At this time, fluorescence is detected to confirm the presence of the detection target substance. Further, when the detection target substance is not a phosphor (fluorescent substance), a substance that has been labeled with a fluorescent dye and that specifically binds to the detection target substance is placed in contact with the sample. Then, fluorescence from the fluorescent dye is detected in a manner similar to the aforementioned method, thereby confirming the presence of the bond between the detection target substance and the substance that specifically binds to the detection target substance. In other words, presence of the detection target substance is confirmed, and this method is widely used.

In bio-measurement, an assay is performed, for example, by using a sandwich method, a competition method or the like. In the sandwich method, when an antigen, as a detection target substance, contained in a sample needs to be detected, a primary antibody that specifically binds to the detection target substance is immobilized on a substrate (base), and a sample is supplied onto the substrate to make the detection target substance specifically bind to the primary antibody. Further, a secondary antibody to which a fluorescent label has been attached, and that specifically binds to the detection target substance, is added to make the secondary antibody bind to the detection target substance. Accordingly, a so-called sandwich structure of (primary antibody)-(detection target substance)-(secondary antibody) is formed, and fluorescence from the fluorescent label attached to the secondary antibody is detected. In the competition method, a competitive secondary antibody that competes with the detection target substance, and that specifically binds to a primary antibody, and to which a fluorescent label has been attached, binds to the primary antibody in such a manner to compete with the detection target substance. Further, fluorescence from the competitive secondary antibody that has bound to the primary antibody is detected.

When the assay is performed as described above, an evanescent fluorescence method has been proposed. In the evanescent fluorescence method, fluorescence is excited by evanescent light to detect fluorescence only from the secondary antibody that has bound, through the detection target substance, to the primary antibody immobilized on the substrate, or fluorescence only from the competitive secondary antibody that has directly bound to the primary antibody. In the evanescent fluorescence method, fluorescence excited by evanescent waves that extend from the surface of the substrate is detected. The evanescent waves are generated by making excitation light that totally reflects on the surface of the substrate enter the substrate from the back side of the substrate.

Japanese Unexamined Patent Publication No. 2005-077338 (Patent Literature 1) proposes an evanescent fluorescence method. In the evanescent fluorescence method disclosed in Patent Literature 1, instead of immobilizing the primary antibody on the substrate, a bound product (bound substance) of (primary reaction body)-(detection target substance)-(secondary reaction body) is formed in liquid phase. Further, the bound product is localized in an area to which the evanescent waves extend, and fluorescence from the bound product is detected. Specifically, the primary reaction body that includes a primary antibody and a magnetic material and the secondary reaction body that includes a fluorescent substance and the secondary antibody are bound to the detection target substance to obtain the bound product. The magnetic material contained in the primary reaction body is attracted by a magnet, and the bound product is localized.

Meanwhile, in the evanescent fluorescent method, methods using electric-field enhancement effects by plasmon resonance are proposed to improve the sensitivity of detection in U.S. Pat. No. 6,194,223 (Patent Literature 2), M. M. L. M. Vareiro et al., “Surface Plasmon Fluorescence Measurements of Human Chorionic Gonadotrophin: Role of Antibody Orientation in Obtaining Enhanced Sensitivity and Limit of Detection”, Analytical Chemistry, Vol. 77, pp. 2426-2431, 2005 (Non-Patent Literature 1), and the like. In a surface plasmon enhancement fluorescence method, a metal layer is provided on the substrate, and excitation light is caused to enter the interface between the substrate and the metal layer from the back side of the substrate at an angle greater than or equal to a total reflection angle to generate surface plasmon resonance in the metal layer. Further, fluorescent signals are enhanced by the electric field enhancement action of the surface plasmons to improve the S/N (signal to noise) ratio.

Similarly, in the evanescent fluorescence method, a method using electric field enhancement effects by a waveguide mode is proposed in Spring 2007, the Japan Society of Applied Physics, Collection of Presentation Abstracts, No. 3, p. 1378 (Non-Patent Literature 2). In this optical waveguide mode enhanced fluorescence spectroscopy (OWF), a metal layer and an optical waveguide layer including a dielectric and the like are sequentially formed on the substrate. Further, excitation light is caused to enter the substrate from the back side of the substrate at an angle that is greater than or equal to the total reflection angle to induce an optical waveguide mode in the optical waveguide layer by irradiation with the excitation light. Further, fluorescent signals are enhanced by the electric field enhancement effect by the optical waveguide mode.

Further, Specification of U.S. Patent Application Publication No. 20050053974 (Patent Literature 3) and T. Liebermann and W. Knoll, “Surface-plasmon field-enhanced fluorescence spectroscopy”, Colloids and Surfaces A, Vol. 171, pp. 115-130, 2000 (Non-Patent Literature 3) propose a method for extracting radiation light (SPCE: Surface Plasmon-Coupled Emission) from the prism side. In the method, instead of detecting fluorescence output from a fluorescent label excited in the electric field enhanced by surface plasmons, the fluorescence newly induces surface plasmons in the metal layer, and radiation light by the newly induced plasmons is extracted from the prism side.

As described above, in bio-measurement or the like, various kinds of methods have been proposed as a method for detecting the detection target substance. In the methods, plasmon resonance or an optical waveguide mode is induced by irradiation with excitation light, and a fluorescent label is excited in an electric field enhanced by the plasmon resonance or the optical waveguide mode, and the fluorescence is directly or indirectly detected.

Further, in surface plasmon resonance measurement apparatuses, methods for increasing the concentration of detection target substance in a region on the sensor portion, the region to which evanescent waves extend from the sensor portion, are proposed in Japanese Unexamined Patent Publication No. 9 (1997)-257702 (Patent Literature 4), Japanese Unexamined Patent Publication No. 2007-085770 (Patent Literature 5), and the like. In Patent Literature 4, Patent Literature 5 and the like, voltage is applied to a sample to attract the detection target substance to the sensor portion, and measurement is performed. In these methods, the pH (potential of hydrogen) of a buffer solution is adjusted to adjust the charge state of a detection target substance, such as protein and nucleic acid. Further, voltage is applied in a state in which the detection target substance is positively or negatively electrified, thereby attracting the detection target substance to the sensor portion.

The method for localizing the detection target substance by application of voltage can achieve a certain effect. Further, Patent Literature 4 describes that in surface plasmon resonance measurement apparatuses, when the detection target substance is attracted to a region within approximately 100 nm from the sensor portion, which the evanescent waves reach, it is possible to reduce the variation in signals.

However, since both of the size and the charge of the detection target substance are small, the attraction effect by application of voltage is weaker than Brown motion of the detection target substance. Therefore, it is difficult to efficiently attract the detection target substance to the surface of the sensor portion.

Further, the electric field enhancement effects by surface plasmon resonance and optical guide mode sharply attenuate as a distance from the surface of the metal layer or the optical waveguide layer increases. Therefore, there is a problem that when the distances from the surface to the fluorescent labels even slightly change, signals from the fluorescent labels become different from each other, and varied. Hence, it is necessary to attract the fluorescent labels within a range of approximately 50 nm from the surface.

For example, FIG. 17 is a schematic diagram illustrating an apparatus for detecting fluorescence by an electric field enhancement effect by surface plasmon resonance. In FIG. 17, the vicinity of a sensor portion of the apparatus is illustrated. A gold film (thin-film, coating or layer) 102 is deposited on a surface of a prism (substrate) 101. Further, primary antibody B₁ is immobilized on the gold film 102. When a sandwich assay is performed, fluorescence from a fluorescent label (fluorescent dye molecule f in this case) attached to labeling secondary antibody B₂ is detected. The labeling secondary antibody B₂ binds to the primary antibody B₁ through antigen A. Excitation light is caused to enter the interface between the prism 101 and the gold film 102 at an angle greater than or equal to the total reflection angle to excite surface plasmons on the surface of the gold film 102. Accordingly, the electric field on the surface of the gold film 102 is enhanced. The fluorescent label (fluorescent dye molecule) f is excited in the enhanced electric field, and fluorescence is output. In FIG. 17, the graph shows distance-dependent characteristic of the strength (magnitude) of the electric field, the distance being measured from the surface of the sensor portion (surface of the gold film). As the graph shows, the strength of the electric field sharply decreases as the distance from the surface increases.

At this time, the maximum distance from the surface of the sensor portion to the fluorescent label f of the labeling secondary antibody is approximately 50 nm. When the distance from the surface of the sensor portion is approximately 50 nm, the intensity of fluorescence attenuates by 30% or more. Further, the primary antibody B₁ is not always immobilized upright on the surface of the sensor portion, and the primary antibody B₁ may fall along the surface by the flow of liquid, a three-dimensional obstacle or the like, and be immobilized in a lying or inclined state. Consequently, the distance from the surface of the fluorescent label f to the surface of the sensor portion is varied, and the intensity of the signal is varied.

### SUMMARY OF THE INVENTION

In view of the foregoing circumstances, it is an object of the present invention to provide a detection method and apparatus that can prevent variation in the intensities of signals, and that can efficiently utilize enhanced electric fields, and that can directly or indirectly detect fluorescence.

Further, it is another object of the present invention to provide a sample cell and a kit for detection that are used in the detection method of the present invention.

A detection method of the present invention is a detection method comprising the steps of:

preparing a sensor chip including a sensor portion that has at least a metal layer deposited on a surface of a dielectric plate;

binding a fluorescent-label binding substance in an amount corresponding to the amount of a detection target substance contained in a liquid sample to the sensor portion by contacting the liquid sample with the sensor portion;

irradiating the sensor portion with excitation light to generate an enhanced optical field on the sensor portion; and

detecting the amount of the detection target substance based on the amount of light generated by excitation of a fluorescent label contained in the fluorescent-label binding substance, the fluorescent label being excited in the enhanced optical field, wherein an electrified fluorescent substance containing a plurality of fluorescent dye molecules enclosed by a material that transmits fluorescence output from the plurality of fluorescent dye molecules is used as the fluorescent label, and wherein the electrified fluorescent substance is attracted to the sensor portion by applying voltage to the liquid sample in a state in which the fluorescent-label binding substance has bound to the sensor portion, and wherein the amount of the detection target substance is detected in the state in which the fluorescent substance is attracted to the sensor portion.

For example, when a fluorescent substance the surface of which is modified with a functional group that exhibits a polarity at least in the liquid sample is used as the fluorescent substance in the fluorescent-label binding substance, it is possible to electrify the fluorescent substance in the liquid sample.

It is desirable that the particle size of the fluorescent substance is greater than or equal to 30 nm. Further, it is more desirable that the particle size of the fluorescent substance is greater than or equal to 70 nm.

In the specification of the present application, when the particle of the fluorescent substance has substantially spherical form, the size of the particle of the fluorescent substance is the diameter of the particle. When the particle does not have spherical form, an average length of the maximum width and the minimum width of the particle is defined as the size of the particle.

Here, the “fluorescent-label binding substance” is a binding substance to which a fluorescent label has been attached. The binding substance in an amount corresponding to the amount of the detection target binds to the surface of the sensor portion. For example, when an assay by a sandwich method is performed, the fluorescent-label binding substance contains a fluorescent label and a binding substance that specifically binds to the detection target substance. When an assay by a competition method is performed, the fluorescent-label binding substance contains a fluorescent label and a binding substance that competes with the detection target substance.

Further, the expression “detecting the amount of the detection target substance” means detecting presence of the detection target substance as well as detecting the amount of the detection target substance. Further, the amount of the detection target substance may mean not only the quantitative amount of the detection target substance but the qualitative value of the detection target substance.

It is desirable that a counter-electrode is arranged in contact with the liquid sample and voltage is applied between the counter-electrode and the metal layer on the dielectric plate to apply the voltage to the liquid sample.

Further, it is desirable that when the fluorescent-label binding substance binds to the sensor portion, first voltage is applied to the liquid sample to attract the electrified fluorescent substance to the sensor portion, and that after at least a part of the fluorescent-label binding substance has bound to the sensor portion, application of the first voltage is stopped and second voltage that generates an electric field that is opposite to the first voltage is applied to the liquid sample to remove the fluorescent-label binding substance that has not bound to the sensor portion from the liquid sample on the sensor portion, and that after the fluorescent-label binding substance that has not bound to the sensor portion is removed, the amount of the detection target substance is detected.

Here, the term “optical field” refers to an electric field generated by evanescent light excited by irradiation with excitation light or by near field light.

Further, the expression “generate an enhanced optical field” means that an enhanced optical field is formed by enhancing the optical field. The optical field may be enhanced by plasmon resonance or excitation of optical waveguide mode.

Further, in the method for “detecting the amount of the detection target substance based on the amount of light generated by excitation of a fluorescent label contained in the fluorescent-label binding substance”, fluorescence from the fluorescent label may be detected directly. Alternatively, the fluorescence may be detected indirectly.

Specifically, the amount of the detection target substance may be detected, for example, in any of the following manners (1) to (4):

(1) Plasmons are excited in a metal layer by irradiation with excitation light, and an enhanced optical field is generated by the plasmons. Further, the amount of the detection target substance is detected by detecting, as light generated by excitation of the fluorescent label, fluorescence output from the fluorescent label by excitation of the fluorescent label;

(2) Plasmons are excited in the metal layer by irradiation with the excitation light, and an enhanced optical field is generated by the plasmons. Further, the amount of the detection target substance is detected by detecting, as light generated by excitation of the fluorescent label, radiation light that radiates from the opposite surface of the dielectric plate. The radiation light radiates by newly inducing plasmons in the metal layer by fluorescence output from the fluorescent label by excitation of the fluorescent label;

(3) The sensor chip includes an optical waveguide layer deposited on the metal layer. An optical waveguide mode is excited in the optical waveguide layer by irradiation with the excitation light, and an enhanced optical field is generated by the optical waveguide mode. Further, the amount of the detection target substance is detected by detecting, as the light generated by excitation of the fluorescent label, fluorescence output from the fluorescent label by excitation of the fluorescent label; and

(4) The sensor chip includes an optical waveguide layer deposited on the metal layer. An optical waveguide mode is excited in the optical waveguide layer by irradiation with the excitation light, and an enhanced optical field is generated by the optical waveguide mode. Further, the amount of the detection target substance is detected by detecting, as the light generated by excitation of the fluorescent label, radiation light that radiates from the opposite-surface of the dielectric plate. The radiation light radiates by newly inducing plasmons in the metal layer by fluorescence output from the fluorescent label by excitation of the fluorescent label.

In the methods (1) and (2), the metal layer may be a metal film (coating, thin-film or the like). Further, excitation light may be caused to enter the interface between the metal film and the substrate from the back side of the substrate at an angle greater than or equal to the total reflection angle to excite surface plasmons on the surface of the metal film. Alternatively, the metal layer may be formed by a metal fine structure body having an uneven pattern on the surface thereof, and the uneven pattern may include projections and depressions at cycles smaller than the wavelength of the excitation light. Alternatively, the metal layer may include a plurality of metal nanorods smaller than the wavelength of the excitation light. The metal layer may be formed in such a manner that localized plasmons are excited in the metal fine structure body or the metal nanorods by irradiation with excitation light.

A detection apparatus of the present invention is used in the detection method of the present invention. The detection apparatus of the present invention is a detection apparatus comprising:

a housing unit that houses a sensor chip including a sensor portion that has at least a metal layer deposited on a surface of a dielectric plate;

an excitation-light irradiation optical system that irradiates the sensor portion with excitation light;

a light detection means that detects light generated by excitation of the fluorescent label in an enhanced optical field generated on the sensor portion by irradiation with the excitation light; and

a voltage application means that applies voltage to the liquid sample when the sensor chip is housed in the housing unit.

A sample cell for detection of the present invention is used in the detection method of the present invention. The sample cell for detection of the present invention is a sample cell for detection comprising:

a base that has a flow path through which a liquid sample flows down;

an injection opening for injecting the liquid sample into the flow path, the injection opening being provided on the upstream side of the flow path;

an air hole for causing the liquid sample that has been injected from the injection opening to flow toward the downstream side of the flow path, the air hole being provided on the downstream side of the flow path; and

a sensor chip portion provided between the injection opening and the air hole in the flow path, wherein the sensor chip portion includes a sensor portion that has at least a metal layer deposited on a sample-contact surface of a dielectric plate that is provided at least as a part of the inner wall of the flow path.

In the sample cell for detection of the present invention, it is desirable that the sensor portion includes an immobilization layer that binds to a fluorescent-label binding substance.

Further, it is desirable that the fluorescent-label binding substance includes, as a fluorescent label, an electrified fluorescent substance containing a plurality of fluorescent dye molecules enclosed by a material that transmits fluorescence output from the plurality of fluorescent dye molecules, and that the fluorescent-label binding substance is immobilized in the flow path on the upstream side of the sensor portion.

In the sample cell of the present invention, when a first binding substance that specifically binds to the detection target substance is immobilized in the immobilization layer, and the fluorescent-label binding substance includes a second binding substance that specifically binds to the detection target substance and binds to the first binding substance through the detection target substance, the sample cell is appropriate to perform an assay by a so-called sandwich method.

In the sample cell of the present invention, when a first binding substance that specifically binds to the detection target substance is immobilized in the immobilization layer, and the fluorescent-label binding substance includes a third binding substance that specifically binds to the first binding substance, competing with the detection target substance, the sample cell is appropriate to perform an assay by a competition method.

Further, an optical waveguide layer may be provided on the metal layer in the sensor portion.

Further, a kit for detection of the present invention is used in the detection method of the present invention. The kit for detection of the present invention is a kit for detection comprising:

a sample cell; and

a solution for labeling,

wherein the sample cell includes:

a base that has a flow path through which a liquid sample flows down;

an injection opening for injecting the liquid sample into the flow path, the injection opening being provided on the upstream side of the flow path;

an air hole for causing the liquid sample that has been injected from the injection opening to flow toward the downstream side of the flow path, the air hole being provided on the downstream side of the flow path;

a sensor chip portion provided between the injection opening and the air hole in the flow path, the sensor chip including at least a metal layer deposited on a sample-contact surface of a dielectric plate that is provided at least as a part of the inner wall of the flow path; and

an immobilization layer that is immobilized on the sensor portion, and that binds to the fluorescent-label binding substance,

and wherein the solution for labeling contains the fluorescent-label binding substance that includes, as a fluorescent label, an electrified fluorescent substance including a plurality of fluorescent dye molecules enclosed by a material that transmits fluorescence output from the plurality of fluorescent dye molecules, and wherein the solution for labeling is injected into the flow path to flow down the flow path together with the liquid sample or after the liquid sample has flowed down the flow path.

In the kit for detection, an optical waveguide layer may be provided on the metal layer in the sensor portion.

In the kit for detection of the present invention, when a first binding substance that specifically binds to the detection target substance is immobilized in the immobilization layer of the sample cell, and the solution for labeling contains the fluorescent-label binding substance that includes a second binding substance that specifically binds to the detection target substance, and which binds to the first binding substance through the detection target substance, the kit for detection of the present invention is appropriate to perform an assay by a sandwich method. Further, when a first binding substance that specifically binds to the detection target substance is immobilized in the immobilization layer of the sample cell, and the solution for labeling contains the fluorescent-label binding substance that includes a third binding substance that specifically binds to the first binding substance, competing with the detection target substance, the kit for detection of the present invention is appropriate to perform an assay by a competition method.

Further, it is desirable that the material of the metal layer contains, as a main component, at least one kind of metal selected from the group consisting of Au, Ag, Cu, Al, Pt, Ni, Ti, and alloys thereof. Here, the term “main component” is defined as a component contained at greater than or equal to 90% by mass.

According to the detection method and apparatus of the present invention, an electrified fluorescent substance including a plurality of fluorescent dye molecules enclosed by a material that transmits fluorescence output from the plurality of fluorescent dye molecules is used as a fluorescent label of a fluorescent-label binding substance that binds to the sensor portion based on the amount of the detection target substance contained in a sample. Further, voltage is applied to the sample to attract the fluorescent substance to the surface of the sensor portion at which the optical field enhancement effect is high. Further, the fluorescent label contained in the fluorescent-label binding substance is excited, and the amount of light generated by the excitation is detected in a state in which the fluorescent substance is attracted to the surface of the sensor portion. Since the light is detected in such a manner, it is possible to efficiently use the optical field on the surface of the sensor portion at which the degree of enhancement of the optical field is high. Further, since it is possible to make the distances from the surface of the sensor portion to the fluorescent labels uniform (even), variation in the intensity of signals can be prevented. In other words, it is possible to detect stable signals at an excellent S/N ratio. Further, it is possible to accurately detect presence and/or the amount of the detection target substance.

When the sample cell for detection of the present invention or the kit for detection of the present invention is used, it is possible to easily carry out the detection method of the present invention. Further, it is possible to effectively use the enhanced optical field, and to prevent variation in the intensity of signals. Further, it is possible to accurately detect presence and/or the amount of the detection target substance.

### BRIEF DESCRIPTION OF THE DRAWINGS

FIG. 1 is a schematic diagram illustrating the structure of a fluorescence detection apparatus according to a first embodiment of the present invention;

FIG. 2 is a diagram illustrating a design modification example of an excitation light irradiation optical system;

FIG. 3 is a schematic diagram illustrating the structure of a fluorescence detection apparatus according to a second embodiment of the present invention;

FIG. 4A is a schematic diagram illustrating the structure of a sensor portion of a sensor chip used in the fluorescence detection apparatus according to the second embodiment of the present invention;

FIG. 4B is a schematic diagram illustrating the structure of a sensor portion of a sensor chip used in the fluorescence detection apparatus according to the second embodiment of the present invention;

FIG. 4C is a schematic diagram illustrating the structure of a sensor portion of a sensor chip used in the fluorescence detection apparatus according to the second embodiment of the present invention;

FIG. 5 is a schematic diagram illustrating the structure of a detection apparatus according to a third embodiment of the present invention;

FIG. 6 is a schematic diagram illustrating the structure of a detection apparatus according to a fourth embodiment of the present invention;

FIG. 7 is a schematic diagram illustrating the structure of a detection apparatus according to a fifth embodiment of the present invention;

FIG. 8 is a schematic diagram illustrating a fluorescent substance having a metal coating;

FIG. 9A is a plan view of a sample cell according to the first embodiment of the present invention;

FIG. 9B is a sectional side view of the sample cell according to the first embodiment of the present invention;

FIG. 10 is a sectional side view of a sample cell according to the second embodiment of the present invention;

FIG. 11 is a diagram illustrating the procedure of an assay by a sandwich method using the sample cell according to the second embodiment of the present invention;

FIG. 12 is a sectional side view illustrating the sample cell according to the third embodiment of the present invention;

FIG. 13 is a diagram illustrating the procedure of an assay by a competition method using the sample cell according to the third embodiment of the present invention;

FIG. 14 is a sectional side view illustrating a design modification example of a sample cell;

FIG. 15 is a schematic diagram illustrating the structure of a kit for detecting fluorescence according to an embodiment of the present invention;

FIG. 16 is a diagram illustrating the procedure of an assay by a sandwich method using the kit for detecting fluorescence; and

FIG. 17 is a diagram illustrating a conventional example.

### DESCRIPTION OF THE PREFERRED EMBODIMENTS

Hereinafter, embodiments of the present invention will be described with reference to the drawings. In each of the diagrams, the size of each unit or element differs from the actual size thereof for the purpose of explanation.

### “Detection Method and Apparatus”

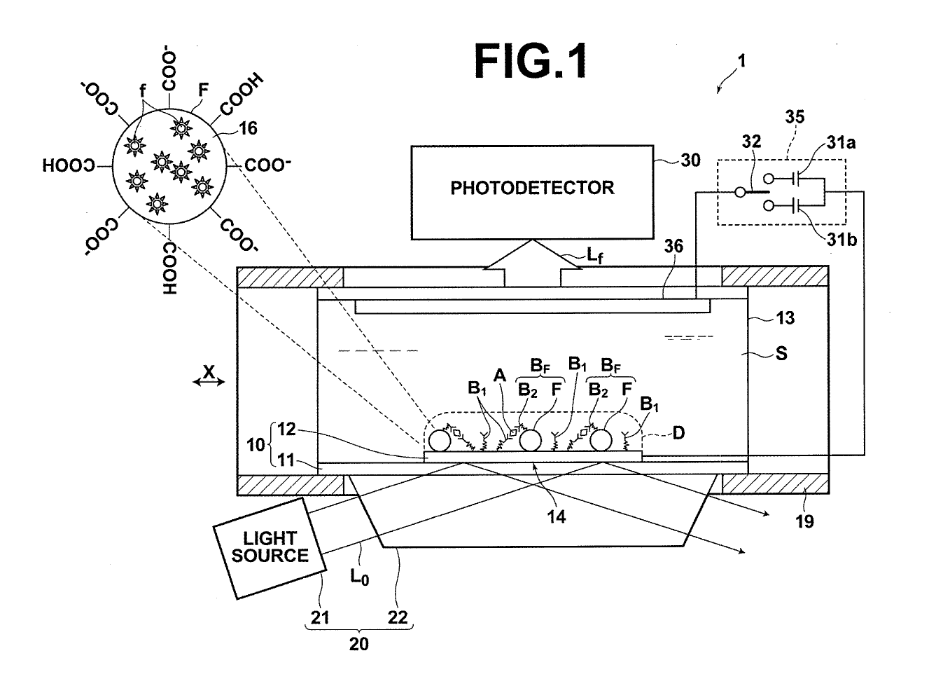

In a detection method according to the present invention, for example, a sensor chip 10 including a dielectric plate 11 and a sensor portion 14, as illustrated in FIG. 1, is used. The sensor portion 14 includes at least a metal layer 12 deposited on a surface of the dielectric plate 11. Further, a sample is placed in contact with the sensor portion 14 to make fluorescent-label binding substance B_{F} in an amount corresponding to the amount of detection target substance A (substance to be detected) contained in the sample bind onto the sensor portion 14. Further, the sensor portion 14 is irradiated with excitation light L₀ to generate an enhanced optical field D on the sensor portion 14, and a fluorescent label F in the fluorescent-label binding substance B_{F} is excited in the enhanced optical field D. Further, the amount of the detection target substance A is detected based on the amount of light generated by excitation of the fluorescent label F. In the detection method of the present invention, an electrified fluorescent substance F including a plurality of fluorescent dye molecules f enclosed by a material that transmits fluorescence output from the plurality of fluorescent dye molecules f is used as a fluorescent label. Further, in a state in which the fluorescent-label binding substance has bound to the sensor portion 14, voltage is applied to the liquid sample to attract the electrified fluorescent substance F to the sensor portion 14. Further, the amount of detection target substance A is detected in the state in which the fluorescent substance F has been attracted to the sensor portion 14.

It is desirable that when the fluorescent-label binding substance binds to the sensor portion 14, first voltage is applied to the liquid sample to attract the electrified fluorescent substance to the sensor portion, and that after at least a part of the fluorescent-label binding substance has bound to the sensor portion, application of the first voltage is stopped and second voltage that generates an electric field that is opposite to the first voltage is applied to the liquid sample to remove the fluorescent-label binding substance that has not bound to the sensor portion from the liquid sample on the sensor portion, and that after the fluorescent-label binding substance that has not bound to the sensor portion is removed, the amount of the detection target substance is detected. When the fluorescent-label binding substance binds to the sensor portion, the fluorescent-label binding substance is attracted to the sensor portion to increase the concentration of the fluorescent-label binding substance in the sensor portion or in the vicinity of the sensor portion, thereby accelerating bond of the fluorescent-label binding substance to the sensor portion. Further, since the second voltage is applied after then, it is possible to efficiently remove remaining or non-specifically-adsorbed fluorescent-label binding substance, which has not bound to the sensor portion, by charge repulsion. Here, the expression “bind to the sensor portion” means specifically binding to the sensor portion. More specifically, a substance to which the fluorescent-label binding substance specifically binds is provided as the immobilization layer in the sensor portion, and binding to the immobilization layer is an example of biding to the sensor portion.

Further, a detection apparatus of the present invention performs the detection method of the present invention. The detection apparatus includes a housing unit 19 for housing the sensor chip 10, an excitation light irradiation optical system 20, a light detection means 30, and a voltage application means 35. The excitation light irradiation optical system 20 irradiates the sensor portion 14 with excitation light L₀, and the light detection means 30 detects light in an amount corresponding to detection target substance A, the light being generated by irradiation with the excitation light L₀. The voltage application means 35 applies voltage to the liquid sample when the sensor chip 10 is housed in the housing unit 19.

It is desirable that a fluorescent substance containing a plurality of fluorescent dye molecules f enclosed (included, encapsulated or the like) by a material 16 that transmits fluorescence output from the plurality of fluorescent dye molecules f is used as the fluorescent label. An enlarged view of the plurality of fluorescent dye molecules f enclosed by the material 16 is illustrated in FIG. 1. The fluorescent substance F containing the plurality of fluorescent dye molecules f enclosed by the material 16 is desirable, because it is possible to increase the amount of fluorescence. Further, since the fluorescent dye molecules f are enclosed by the material 16 that transmits fluorescence L_{f}, it is possible to maintain a distance that is longer than or equal to a predetermined distance from the metal layer. Hence, it is possible to prevent metal quenching that occurs when the fluorescent dye molecules f are close to the metal layer 12.

When the fluorescent dye molecules are located too close to the metal layer, quenching occurs due to energy transfer to the metal. When the metal is a flat plane having a semi-infinite thickness, the magnitude (degree) of energy transfer is in inverse proportion to the cube of the distance. When the metal is a flat plane having a finitely thin thickness, the magnitude of energy transfer is in inverse proportion to the fourth power of the distance. Further, when the metal is microparticles, the magnitude of energy transfer is in inverse proportion to the sixth power of the distance. Therefore, it is desirable that the distance between the metal layer 12 and the fluorescent dye molecules f is at least a few nm, and it is more desirable that the distance is greater than or equal to 10 nm.

Conventionally, a method for preventing metal quenching is well known. In the method, a self-assembled monolayer (SAM) is formed on the metal layer 12, and further carboxymethyl dextran (CMD) coating is applied to the SAM to make the metal layer and the fluorescent dye molecule apart from each other. However, formation of such layers or coatings on the metal layer to prevent metal quenching complicates the process of producing the sensor chip, and greatly increases the operation process. In contrast, when the fluorescent substance F, as described above, is used, it is possible to effectively prevent metal quenching by using an extremely simple method without providing the layer or coating for preventing metal quenching.

As the material 16, polystyrene, SiO₂, or the like may be used for example. However, the material is not limited to these materials as long as the material can enclose the fluorescent dye molecules f, and transmit fluorescence from the fluorescent dye molecules f to output the fluorescence to the outside of the fluorescent substance.

Further, it is desirable that when voltage is applied to the liquid sample, the fluorescent substance has been electrified with charges in such a manner that the attraction effect to the electrode surpasses (exceeds) Brown motion in the liquid sample. Examples of protein and biomolecules that may be detected, as the detection target substance, and that have large sizes are antibodies (15 nm or less), albumin (20 nm or less), and the like. However, even if such detection target substances are electrified, the attraction effect is not sufficient. Therefore, it is desirable that the size (diameter) of a particle of the fluorescent substance is approximately 30 nm or more. If the size of the particle is less than 30 nm, there is a risk that a sufficient attraction effect is not achieved because of the Brown action of the substance. Further, when the size of the particle of the fluorescent substance is 70 nm or more, a more effective attraction effect is expected. Further, when the size of the particle of the fluorescent substance is 100 nm or more, an even more effective attraction effect can be expected.

Further, it is desirable that the size of the particle is less than or equal to 5300 nm for diffusion time. Further, when a fluorescence amount, highest-density loading of the substance onto the sensor portion, and surface plasmon disturbance are considered, it is more desirable that the size of the particle is in the range of 70 nm to 900 nm. Further, it is even more desirable that the size of the particle is in the range of 130 nm to 500 nm.

The fluorescent substance F may be produced, for example, as follows:

First, polystyrene particles (Estapor, ø500 nm, 10% solod, carboxyl group, product No. K1-050) are prepared to obtain 0.1% solid in phosphate (polystyrene solution: pH7.0).

Next, an acetic acid ethyl solution (1 mL) containing 0.3 mg of fluorescent dye molecules (Hayashibara Biochemical Labs., Inc., NK-2014 (excitation ˜780 nm)) is produced.

Further, the polystyrene solution and the fluorescent dye solution are mixed together, and impregnated while the mixture evaporates. After then, centrifugation (15000 rpm, 4° C., 20 minutes, twice) is performed, and the supernatant is removed. Accordingly, fluorescent substance F, in which fluorescent dye is enclosed by polystyrene, is obtained. When the fluorescent substance F is produced by impregnating the fluorescent dye into the polystyrene particle through the aforementioned processes, the size or diameter of the particle of the fluorescent substance F is the same as that of polystyrene particle (ø500 nm in the above example). Further, since the surface of the polystyrene particle that is used in the above process is modified with a carboxyl group, the surface of the fluorescent substance F is also modified with the carboxyl group. The carboxyl group is a functional group the charge state of which changes according to pH. The carboxyl group is ionized in the liquid sample, and fluorescent substance F is negatively electrified.

The fluorescent-label binding substance B_{F} is a binding substance to which a fluorescent label has been attached, and the fluorescent-label binding substance B_{F} in an amount corresponding to the amount of the detection target substance A binds onto the sensor portion 14. As illustrated in FIG. 1, when an assay is performed by a sandwich method, the fluorescent-label binding substance B_{F} includes a binding substance that specifically binds to the detection target substance and the aforementioned fluorescent substance F. When an assay is performed by using a competition method, which will be described later, the fluorescent-label binding substance B_{F} includes a binding substance that competes with the detection target substance and the fluorescent substance F. Specifically, when the sensor chip 10 in which first binding substance B₁ that specifically binds to the detection target substance A is immobilized, as an immobilization layer, in the sensor portion 14 is used, the fluorescent-label binding substance B_{F} including second binding substance B₂ that specifically binds to the detection target substance A and fluorescent substance F that is modified with the binding substance B₂ is used in the sandwich method. In the competition method, the fluorescent-label binding substance B_{F} including a third binding substance that competes with the detection target substance A and that specifically binds to the first binding substance B₁ and fluorescent substance F that is modified with the third binding substance is used. When the detection target substance A is an antigen, a so-called primary antibody should be used as the first binding substance B₁, and a so-called labeling secondary antibody should be used as the fluorescent-label binding substance.

As a method for electrifying the fluorescent substance F, it is desirable that the surface of the fluorescent substance F is modified with a functional group that exhibits polarity at least in a liquid sample. For example, as the functional group that is ionized in the liquid sample to be positively or negatively charged, carboxyl group, sulfone group, phosphoric acid group, amino group, quaternary ammonium group, imidazole group, guanidinium group, and the like may be used. For example, the carboxyl group (—COOH) is ionized (COO⁻) in a liquid sample, such as a blood serum or blood plasma, or in phosphoric-acid buffer physiologic saline (Phosphate buffered saline, PBS) or the like. Therefore, the fluorescent substance F is negatively electrified. Further, the amino group (—NH₂) is ionized (NH₃⁺) in a liquid sample, such as a blood serum or blood plasma, or in PBS or the like. Therefore, the fluorescent substance F is positively electrified.

When the fluorescent substance is negatively charged, if the metal layer side is used as a positive electrode to apply voltage, the fluorescent substance is attracted to the metal layer. In contrast, when the fluorescent substance is positively charged, if the metal layer side is used as a negative electrode to apply voltage, the fluorescent substance is attracted to the metal layer.

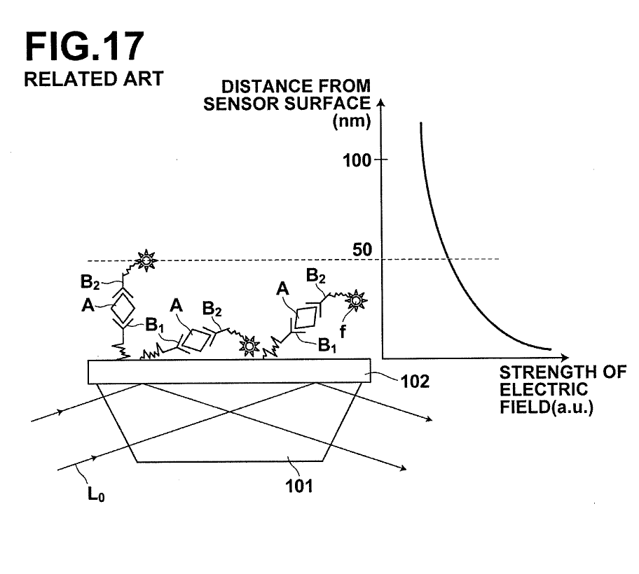

In the example illustrated in FIG. 17, which has been described already, the fluorescent label is not sufficiently attracted to the metal layer. Further, the distance from the sensor surface to the fluorescent label is varied because the bond products are upright, lying or the like. However, if the fluorescent substance that is used as the fluorescent label is electrified, it is possible to efficiently and evenly (uniformly) attract the fluorescent substance to the surface of the sensor. Accordingly, it is possible to detect stable signals at an excellent S/N ratio.

In the present invention, the enhanced optical field is generated on the sensor portion by irradiation with excitation light, and light output by excitation of the fluorescent label in the enhanced optical field is detected. The optical field may be enhanced by surface plasmon resonance, or by localized plasmon resonance. Alternatively, the optical field may be enhanced by excitation of an optical waveguide mode. Further, fluorescence output from the fluorescent label may be detected either directly or indirectly. Specific examples will be described in each of the following embodiments.

### First Embodiment

A detection method and apparatus according to a first embodiment will be described with reference to FIG. 1. FIG. 1 is a schematic diagram illustrating the structure of the whole detection apparatus of the first embodiment. The detection method and apparatus of this embodiment is a fluorescence detection method and apparatus that enhances an optical field by surface plasmon resonance, and detects fluorescence excited in the enhanced optical field.

In the fluorescence detection method of the present embodiment, a sensor chip 10 including a dielectric plate 11 and a sensor portion 14 that has at least a metal coating (metal film or thin-film or the like), as a metal layer 12, deposited in a predetermined area on a surface of the dielectric plate 11 is used. Further, a sample retaining unit 13 for retaining liquid sample S on the sensor chip 10 is provided. The sensor chip 10 and the sample retaining unit 13 constitute a box-form sample cell that can retain the liquid sample. Further, a counter-electrode 36 is provided on the upper plate of the sample retaining unit 13. The counter-electrode 36 applies voltage to the liquid sample that fills the space between the counter-electrode 36 and the metal layer 12.

The metal layer (film) 12 may be formed on a surface of the dielectric plate 11 by forming (placing) a mask that has an opening in the predetermined area, and by depositing metal by using a well-known vapor-deposition method (evaporation method). It is desirable that the thickness of the metal layer 12 is appropriately determined, based on the material of the metal layer 12 and the wavelength of the excitation light, so that surface plasmons are strongly excited. For example, when a laser beam that has a center wavelength of 780 nm is used as the excitation light, and a gold (Au) film is used as the metal layer 12, it is desirable that the thickness of the metal layer is 50 nm±20 nm. Further, it is more desirable that the thickness is 47 nm±10 nm. Further, it is desirable that the metal layer contains, as a main component, at least one kind of metal selected from the group consisting of Au, Ag, Cu, Al, Pt, Ni, Ti, and alloys thereof.

The detection apparatus 1 of the present invention includes a housing unit 19 that houses the sensor chip 10. The detection apparatus 1 also includes an excitation light irradiation optical system 20, and a photodetector 30. The excitation light irradiation optical system 20 causes excitation light L₀ to enter the interface between the dielectric plate 11 and the metal layer 12 of the sensor chip 10 housed in the housing unit 19 from the opposite surface of the sensor chip 10, the opposite surface being opposite to the metal-layer-formation surface of the sensor chip 10, at an angle greater than or equal to a total reflection angle. The photodetector 30 detects fluorescence L_{f} output by irradiation with the excitation light L₀. Further, a voltage application means 35 for applying voltage to the liquid sample when the sensor chip is housed in the housing unit 19 is provided.

The excitation-light irradiation optical system 20 includes a light source 21, such as a semiconductor laser (LD), which outputs the excitation light L₀. Further, the excitation-light irradiation optical system 20 includes a prism 22 arranged in such a manner that a surface of the prism 22 contacts the dielectric plate 11. The prism 22 guides the excitation light L₀ into the dielectric plate 11 so that the excitation light L₀ totally reflects at the interface between the dielectric plate 11 and the metal layer 12. Further, the prism 22 and the dielectric plate 11 are in contact with each other through refractive-index-matching oil. The light source 21 is arranged in such a manner that the excitation light L₀ enters the prism from another surface of the prism 22 and enters a sample-contact-surface 10a of the sensor chip 10 at an angle greater than or equal to a total reflection angle. Further, the light source 21 is arranged in such a manner that the excitation light L₀ enters the metal layer at a specific angle that generates surface plasmon resonance. Further, a light guide member may be arranged between the light source 21 and the prism 22, if necessary. Further, the excitation light L₀ is caused to enter the interface between the dielectric plate 11 and the metal layer 12 in a p-polarized light state so as to generate surface plasmons.

As the photodetector 30, a CCD, a PD (photodiode), a photomultiplier, c-MOS or the like may appropriately be used.

The housing unit 19 is structured in such a manner that when the sensor chip 10 is housed in the housing unit 19, the sensor portion 14 of the sensor chip 10 is arranged on the prism 22 and fluorescence is detected by the photodetector 30. The cell (sensor chip 10) can be inserted into the housing unit 19 or removed therefrom in the direction of arrow X in FIG. 1.

The voltage application means 35 includes a direct-current power source 31 and a switch 32 for turning on/off voltage. In the present embodiment, a first power source 31a and a second power source 31b are provided. The first power source 31a uses the metal layer (metal film or coating) as a positive electrode and applies first voltage. The second power source 31b uses the metal layer as a negative electrode and applies second voltage. The first power source 31a and the second power source 31b are appropriately switched by the switch 32. The voltage application means 35 uses the metal layer 12 deposited on the dielectric plate 11 as an electrode, and applies voltage between the metal layer 12 and the counter-electrode 36. Further, the counter-electrode 36 provided on the upper plate of the cell is constituted of a transparent electrode. As the counter-electrode 36, a metal electrode that has an opening for detecting fluorescence may be provided.

Here, a case in which the metal layer is used as the electrode has been described. Alternatively, instead of using the metal layer as the electrode, a separate electrode may be provided in the vicinity of the sensor portion. When the metal layer is not used as the electrode, a metal electrode should be provided in the vicinity of the measurement portion by vapor-deposition (evaporation) or by plating. Further, the dielectric plate 11 may be made of a transparent resin that is highly electrically conductive, such as polyaniline and polypyrrole. In such a case, the dielectric plate 11 may be made of polyaniline or the like alone. Alternatively, polyaniline or the like may be mixed with another resin, such as polystyrene, in such a manner that the mixture exhibits electric conductivity. Further, it is not necessary that the counter-electrode is provided on the upper plate of the sample retaining unit. Alternatively, an electrically conductive material that can be inserted into the liquid sample and removed therefrom may be used as the counter-electrode.

A fluorescence detection method according to the present invention using the fluorescence detection apparatus 1 will be described.

Here, a case in which antigen A contained in sample S is detected as measurement target substance will be described.

As the sensor chip 10, a sensor chip in which a metal film (metal layer) 12 of the sensor chip 10 is modified with primary antibody B₁ as an immobilization layer is prepared. The primary antibody B₁ is the first binding substance that specifically binds to the antigen A.

First, liquid sample S, which is an examination object (assay target or examination target), is poured into the sample retaining unit 13 to make the liquid sample S in contact with the metal film 12 of the sensor chip 10. Next, a solution containing fluorescent-label binding substance (labeling secondary antibody) B_{F} is poured into the sample retaining unit 13 in a similar manner. The fluorescent-label binding substance B_{F} includes secondary antibody B₂, which is a second binding substance that specifically binds to the antigen A, and fluorescent label F. In this case, the primary antibody B₁ that is used for surface modification of the metal film 12 and the secondary antibody B₂ of the fluorescent-label binding substance B_{F} are selected so that they bind to different sites of the antigen A, which is the detection target substance. Here, fluorescent substance F that includes fluorescent dye molecules f, and the surface of which is modified with carboxyl group (—COOH), is used as the fluorescent label. The carboxyl group is ionized (COO⁻) in the liquid sample, and the fluorescent substance F is negatively electrified.

When the antigen A is present in the sample S, the antigen A specifically binds to the primary antibody B₁, and the secondary antibody B₂ in the fluorescent-label binding substance B_{F} binds to the antigen A. Consequently, a bound body of (primary antibody B₁)-(antigen A)-(secondary antibody B₂) (hereinafter, referred to as a sandwich bound body) is formed. At this time, if a switch 32 of the voltage application means 35 is connected to a first power source 31a, and first voltage is applied between electrodes by using the metal layer 12 side as the positive electrode, the fluorescent-label binding substance B_{F} including the negatively charged fluorescent substance F is attracted to the metal layer 12. Consequently, the concentration of the fluorescent-label binding substance on the metal layer is increased. Therefore, the antigen-antibody reaction can be accelerated, and the reaction time can be reduced.

After then, a buffer solution (buffer) is poured into the sample retainer unit 13 to separate the sandwich bound body from unreacted fluorescent-label binding substance B_{F}. Consequently, the unreacted fluorescent-label binding substance B_{F} is eliminated. At this time, if the switch 32 of the voltage application means 35 is connected to a second power source 31b, and second voltage is applied between electrodes by using the metal layer 12 side as the negative electrode, charge repulsion acts on the negatively electrified fluorescent substance F. Hence, the unreacted fluorescent-label binding substance is efficiently eliminated.

Further, the timing of labeling the detection target substance (antigen A) is not particularly limited. A fluorescent label may be added to the sample in advance before the detection target substance (antigen A) binds to the first binding substance (primary antibody B₁).

After then, with the sensor chip 10 set in the housing unit 19, the switch of the voltage application means 35 is connected to the first power source, and voltage is applied between electrodes by using the metal layer 12 side as the positive electrode. Accordingly, the negatively electrified fluorescent substance F of the fluorescent-label binding substance B_{F} that has bound to the sensor portion is attracted to the sensor portion 14. In a state in which the fluorescent substance F is attracted to the sensor portion 14 as described above, excitation light L₀ is output to a predetermined area of the dielectric plate 11 of the sensor chip 10 from the excitation light irradiation optical system 20. The excitation light irradiation optical system 20 outputs the excitation light L₀ in such a manner that the excitation light L₀ enters the interface between the dielectric plate 11 and the metal layer 12 at a specific incident angle that is greater than or equal to a total reflection angle. When the light L₀ enters the interface in such a manner, evanescent waves extend to the sample S on the metal layer 12, and surface plasmons are excited in the metal layer 12 by the evanescent waves. Further, the optical field (an electric field induced by evanescent waves) that has been generated on the metal layer by the incident excitation light is enhanced by the surface plasmons. Accordingly, optical field enhanced region D is formed on the metal layer. Since the electrified fluorescent substance F has been attracted to the surface of the metal layer in the optical field enhanced region D by application of voltage by the voltage application means 35, the fluorescent substance F is excited (fluorescent dye molecules f in the fluorescent substance are substantially excited), and fluorescence L_{f} is output. The fluorescence is enhanced by the optical field enhancement effect by the surface plasmons. The fluorescence L_{f} is detected by the photodetector 30. Therefore, it is possible to detect the presence and/or amount of the detection target substance that has bound to the fluorescent-label binding substance by detecting fluorescence at the photodetector 30.

Further, when the process of forming a sandwich bound body on the sensor portion and separating the sandwich bound body from the unreacted fluorescent-label binding substance B_{F} is performed, it is not always necessary that voltage is applied. When voltage is not applied, this process may be performed before the sensor chip 10 is set in the housing unit 19 of the detection apparatus 1. Alternatively, the process may be performed after the sensor chip 10 is set. In this case, it is sufficient if a power source, as a direct current power source, that applies voltage by using the metal layer as the negative electrode is provided.

As described above, an electric field is generated in the sample by application of voltage between the electrodes. Therefore, it is possible to detect fluorescence in a state in which the electrified fluorescent substance is attracted to the sensor portion. Hence, it is possible to obtain stable signals at an excellent S/N ratio. Further, it is possible to improve the reliability of examination.

### DESIGN MODIFICATION EXAMPLE OF FIRST EMBODIMENT

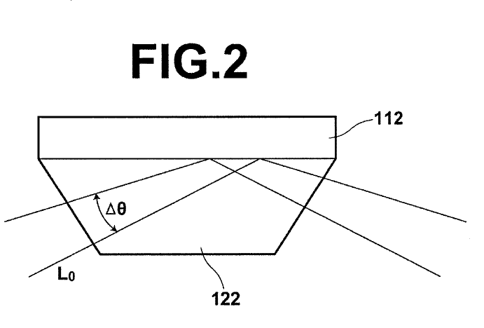

In each of the aforementioned examples, the excitation light L₀ is collimated light that enters the interface at predetermined angle θ. Alternatively, the excitation light may be a fan beam (condensed light), as schematically illustrated in FIG. 2, which has angle width Δθ with respect to angle θ. When the excitation light is a fan beam, the excitation light enters the interface between the prism 122 and the metal film 112 on the prism 122 at an incident angle within the range of θ−Δθ/2 to θ+Δθ/2. When a resonance angle is present in the range of angles, it is possible to excite surface plasmons in the metal film 112. Further, the refractive index of the medium changes when the sample is supplied onto the metal film. In other words, the refractive index of the medium before supply of the sample and the refractive index of the medium after supply of the sample differ from each other. Therefore, the resonance angle at which surface plasmons are generated changes. When the collimated light is used as the excitation light as in the aforementioned examples, it is necessary to adjust the incident angle of the collimated light every time when the resonance angle changes. However, when the fan beam, as illustrated in FIG. 2, the incident angle of which has a certain width, is used, it is possible to cope with the change in the resonance angle without adjusting the incident angle. Further, it is desirable that the fan beam has flat distribution, in which a change in the intensity of light according to the incident angle is small.

### Second Embodiment

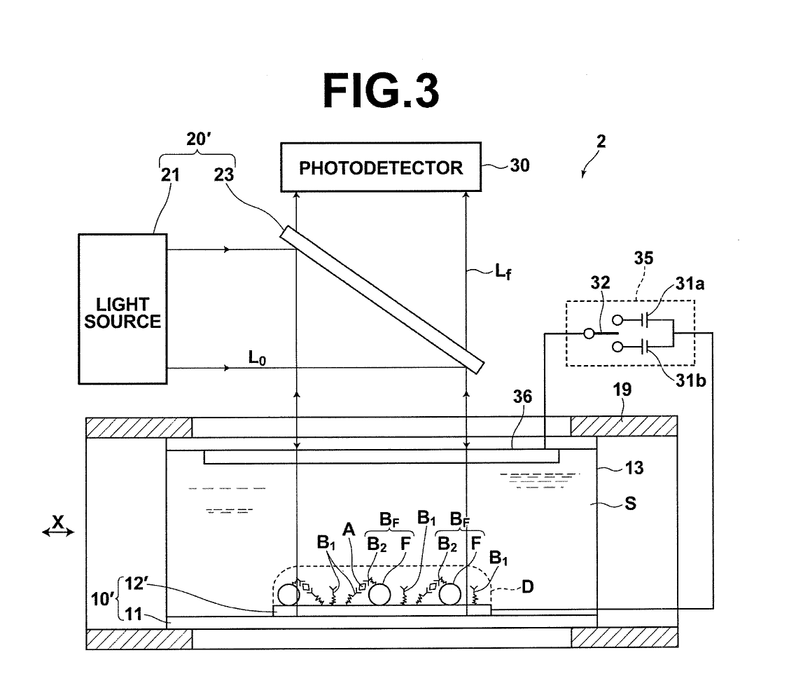

A detection method and apparatus according to a second embodiment will be described with reference to FIG. 3. FIG. 3 is a schematic diagram illustrating the structure of the whole detection apparatus of the second embodiment. The detection method and apparatus in this embodiment enhances an optical field by localized plasmon resonance, and detects fluorescence excited in the enhanced optical field. In the following descriptions, the same reference numerals will be assigned to elements corresponding to the elements in the first embodiment.

In a fluorescence detection apparatus 2 illustrated in FIG. 3, a sensor chip 10′ and an excitation light irradiation optical system 20′ differ from the elements of the fluorescence detection apparatus 1 of the first embodiment.

The sensor chip 10′ includes, as a metal layer 12′ provided on the dielectric plate 11, a metal fine structure body or a plurality of metal nanorods, which generate so-called localized plasmons by irradiation with the excitation light. The metal fine structure body includes an uneven structure (an uneven pattern, or projections/depressions) that is smaller than the wavelength of the excitation light L₀. Further, the size of each of the plurality of metal nanorods is smaller than the wavelength of the excitation light L₀. When the metal layer 12′ as described above, which generates localized plasmons, is provided, it is not necessary that the excitation light enters the interface between the metal layer 12′ and the dielectric plate 11 at a total reflection angle. Therefore, an excitation light irradiation optical system 20′ is arranged in such a manner that the excitation light L₀ is output to the sensor chip 10′ from the upper side of the dielectric plate 11.

The excitation light irradiation optical system 20′ includes a light source 21, such as a semiconductor laser (LD), and a half mirror 23. The light source 21 outputs the excitation light L₀, and the half mirror 23 reflects the excitation light L₀, and guides the excitation light L₀ to the sensor chip 10′. The half mirror 23 reflects the excitation light L₀, and transmits fluorescence L_{f}.

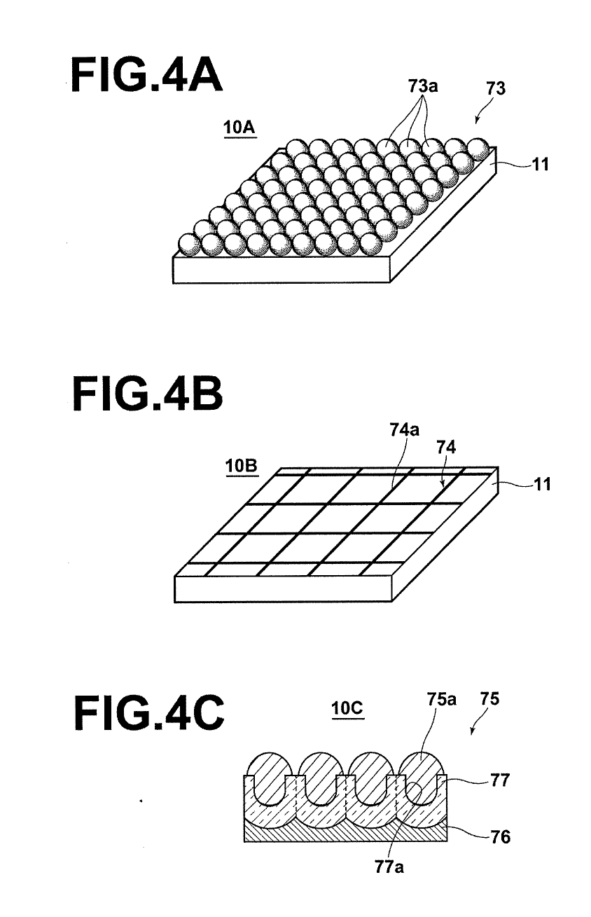

A specific example of the sensor chip 10′ will be described with reference to perspective views illustrated in FIGS. 4A through 4C.

A sensor chip 10A illustrated in FIG. 4A includes the dielectric plate 11 and a metal fine structure body 73. The metal fine structure body 73 includes a plurality of metal particles 73a fixed in array form on a predetermined area of the dielectric plate 11. The arrangement pattern of the metal particles 73a may be appropriately designed, and it is desirable that the arrangement pattern is substantially regular. This structure is designed in such a manner that an average particle diameter of the metal particles 73a and an average pitch thereof are smaller than the wavelength of the excitation light L₀.

A sensor chip 10B illustrated in FIG. 4B includes the dielectric plate 11 and a metal fine structure body 74 provided on a predetermined area of the dielectric plate 11. The metal fine structure body 74 is formed by a metal pattern layer. In the metal pattern layer, metal thin wires 74a are arranged in grid form by pattern formation. The pattern of the metal pattern layer may be appropriately designed, and it is desirable that the pattern is substantially regular. This structure is designed in such a manner that an average width (line width) of the metal thin wires 74a and an average pitch thereof are smaller than the wavelength of the excitation light L₀.

A sensor chip 10C illustrated in FIG. 4C includes a metal fine structure body 75 as disclosed in U.S. Patent Application Publication No. 20070158549. The metal fine structure body 75 includes a plurality of mushroom-shape metals 75a that have grown in a plurality of minute pores (holes) 77a in a metal oxide object 77. The minute pores 77a are formed in the process of anodic oxidation of a metal 76, such as Al. Here, the metal oxide object 77 corresponds to the dielectric plate 11. The metal fine structure body 75 can be produced by obtaining a metal oxide object (Al₂O₃ or the like) by performing anodic oxidation on a part of a metal body (Al or the like) and by making the metal 75a grow in each of the plurality of minute pores 77a in the metal oxide object 77 by plating or the like. The plurality of minute pores 77a are formed in the process of anodic oxidation.

In the example illustrated in FIG. 4C, the top portion of the mushroom-shape metal 75a has particle form. Therefore, when the metal fine structure body 75 is observed from the surface of the sample plate, the metal fine structure body 75 is structured in such a manner that metal microparticles are arranged. In this structure, the top portions of the mushroom-shape metals 75a are projections (projections in an uneven pattern), and the structure is designed in such a manner that an average diameter of the projections (top portions) and an average pitch thereof are smaller than the wavelength of excitation light L₀.

Further, as the metal layer 12′, which generates localized plasmons by irradiation with excitation light, various kinds of other metal fine structure bodies may be used. The various kinds of metal fine structure bodies utilize fine structures obtained by performing anodic oxidation on metal bodies, as disclosed in U.S. Patent Application Publication No. 20060234396, U.S. Patent Application Publication No. 20060181701, and the like.

Further, the metal layer that generates localized plasmons may be formed by a metal film (coating) the surface of which has been coarsened. As a method for coarsening the surface, there is an electro-chemical method utilizing oxidation/reduction or the like. Further, the metal layer may include a plurality of metal nanorods arranged on a sample plate. The short-axial length of the metal nanorods is approximately 3 nm to 50 nm, and the long-axial length of the metal nanorods is approximately 25 nm to 1000 nm. Further, the long-axial length should be less than the wavelength of the excitation light. The metal nanorods are disclosed, for example, in U.S. Patent Application Publication No. 20070118936, or the like.

Further, it is desirable that the metal fine structure body and the metal nanorods, which are used as the metal layer 12′, contain, as a main component, at least one kind of metal selected from the group consisting of Au, Ag, Cu, Al, Pt, Ni and Ti and alloys thereof.

Next, a fluorescence detection method of the present embodiment using the fluorescence detection apparatus 2 will be described.

The processes of preparing a sensor chip and carrying out antigen-antibody reaction are similar to the processes in the first embodiment. Therefore, the explanation about these processes will be omitted in the following embodiments.

With the sensor chip 10′ set in the housing unit 19, the switch of the voltage application means 35 is connected to the first power source, and voltage is applied between electrodes by using the metal layer 12 side as the positive electrode. Accordingly, the negatively electrified fluorescent substance F of the fluorescent-label binding substance B_{F} that has bound to the sensor portion 14 is attracted to the sensor portion 14. In a state in which the fluorescent substance F is attracted to the sensor portion 14 as described above, excitation light L₀ is output to a predetermined area on the dielectric plate 11 of the sensor chip 10′ from the excitation light irradiation optical system 20′. The excitation light L₀ output from the light source 21 is reflected by a half mirror 23, and enters the sample-contact surface of the sensor chip 10′. Consequently, localized plasmons are excited on the surface of the metal layer 12′ by irradiation with the excitation light L₀. Further, the optical field (an electric field induced by near field light) that has been generated on the metal layer by the incident excitation light is enhanced by the localized plasmons. Accordingly, optical field enhanced region D is formed on the metal layer. Since the electrified fluorescent substance F has been attracted to the surface of the metal layer in the optical field enhanced region D by application of voltage by the voltage application means 35, the fluorescent substance F is excited (fluorescent dye molecules f in the fluorescent substance are substantially excited), and fluorescence L_{f} is output. The fluorescence is enhanced by the optical field enhancement effect by the localized plasmons. The fluorescence L_{f} is detected by the photodetector 30. Therefore, it is possible to detect the presence and/or amount of the detection target substance that has bound to the fluorescent-label binding substance by detecting fluorescence at the photodetector 30.

In the present embodiment, the fluorescent-label binding substance includes electrified fluorescent substance, and fluorescence is detected in a state in which the fluorescent substance is attracted to the sensor portion. Therefore, it is possible to achieve an advantageous effect similar to the first embodiment.

### Third Embodiment

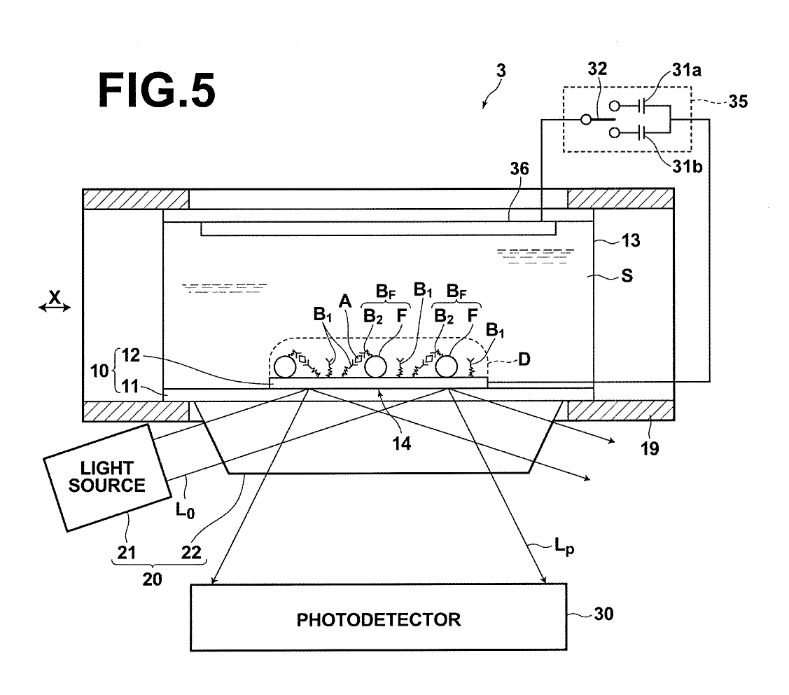

A detection method and apparatus according to a third embodiment will be described with reference to FIG. 5. FIG. 5 is a schematic diagram illustrating the structure of the detection apparatus of the third embodiment. The detection method and apparatus in this embodiment enhances an electric field by surface plasmon resonance, and fluorescence excited in the enhanced electric field newly induces plasmons in the metal layer. Further, light from the newly-induced plasmons radiates from the opposite surface of the dielectric plate, the opposite surface being opposite to the metal-layer-formation surface of the dielectric plate. Further, radiation light from the newly induced plasmons is detected in the radiation light detection method and apparatus of this embodiment.

In a radiation light detection apparatus 3, illustrated in FIG. 5, the arrangement of the photodetector is different from the arrangement of the photodetector in the fluorescence detection apparatus of the first embodiment. In the radiation light detection apparatus 3 of the present embodiment, the photodetector 30 is arranged in such a manner that radiation light Lₚ from the newly induced plasmons is detected. The plasmons are newly induced in the metal layer by fluorescence, and the radiation light Lₚ from the newly induced plasmons radiates from the opposite surface of the dielectric plate, the opposite surface being opposite to the metal layer formation surface of the dielectric plate.

A radiation light detection method of the present embodiment using the radiation light detection apparatus 3 will be described.

With the sensor chip 10 set in the housing unit 19, the switch of the voltage application means 35 is connected to the first power source, and voltage is applied between electrodes by using the metal layer 12 side as the positive electrode. Accordingly, the negatively electrified fluorescent substance F of the fluorescent-label binding substance B_{F} that has bound to the sensor portion is attracted to the sensor portion 14. In this state, in which the fluorescent substance F is attracted to the sensor portion 14, excitation light L₀ is output from the excitation light irradiation optical system 20 in a manner similar to the first embodiment. The excitation light irradiation optical system 20 outputs the excitation light L₀ in such a manner that the excitation light L₀ enters the interface between the dielectric plate 11 and the metal layer 12 at a specific incident angle that is greater than or equal to a total reflection angle. When the light L₀ enters the interface in such a manner, evanescent waves extend to the sample S on the metal layer 12, and surface plasmons are excited in the metal layer 12 by the evanescent waves. Further, the optical field (an electric field induced by evanescent waves) that has been generated on the metal layer by the incident excitation light is enhanced by the surface plasmons. Accordingly, optical field enhanced region D is formed on the metal layer. Since the electrified fluorescent substance F has been attracted to the surface of the metal layer in the optical field enhanced region D by application of voltage by the voltage application means 35, the fluorescent substance F is excited (fluorescent dye molecules f in the fluorescent substance are substantially excited), and fluorescence L_{f} is output. The fluorescence is enhanced by the optical field enhancement effect by the surface plasmons. The fluorescence L_{f} generated on the metal film 12 newly induces surface plasmons in the metal film 12, and radiation light Lₚ is output by the surface plasmons at a specific angle from an opposite surface of the sensor chip 10, the opposite surface being opposite to the metal film formation surface of the sensor chip 10. Further, the radiation light Lₚ is detected by the photodetector 30. Accordingly, it is possible to detect the presence and/or amount of the detection target substance that has bound to the fluorescent-label binding substance.

The radiation light Lₚ is generated when fluorescence couples to surface plasmons of a specific wavenumber in the metal film. The wavenumber of the surface plasmons that couple to the fluorescence is determined by the wavelength of the fluorescence. Further, the output angle of radiation light is determined by the wavenumber. Ordinarily, the wavelength of excitation light L₀ and the wavelength of fluorescence differ from each other. Therefore, the wavenumber of the surface plasmons excited by the fluorescence differs from that of the surface plasmons generated by the excitation light L₀. Therefore, the radiation light Lₚ is output at an angle different from the incident angle of the excitation light L₀.

In the present embodiment, the fluorescent-label binding substance includes electrified fluorescent substance, and fluorescence is generated in a state in which the fluorescent substance is attracted to the sensor portion. Further, radiation light induced by the enhanced fluorescence is detected. Therefore, it is possible to achieve an advantageous effect similar to the first embodiment.

Further, in the present embodiment, light caused by the fluorescence generated on the surface (front surface) of the sensor is detected from the back side of the sensor. Therefore, it is possible to reduce the distance of a solvent through which the fluorescence L_{f} passes (travels), and which greatly absorbs light, to approximately several tens nm. Therefore, it is possible to substantially ignore light absorption, for example, in blood. Therefore, it is possible to perform measurement without performing pre-processing, such as centrifuging the blood to remove a colored component, such as red blood cells, from the blood, and filtering the blood through a blood cell filter to obtain blood serum or blood plasma.

### Fourth Embodiment

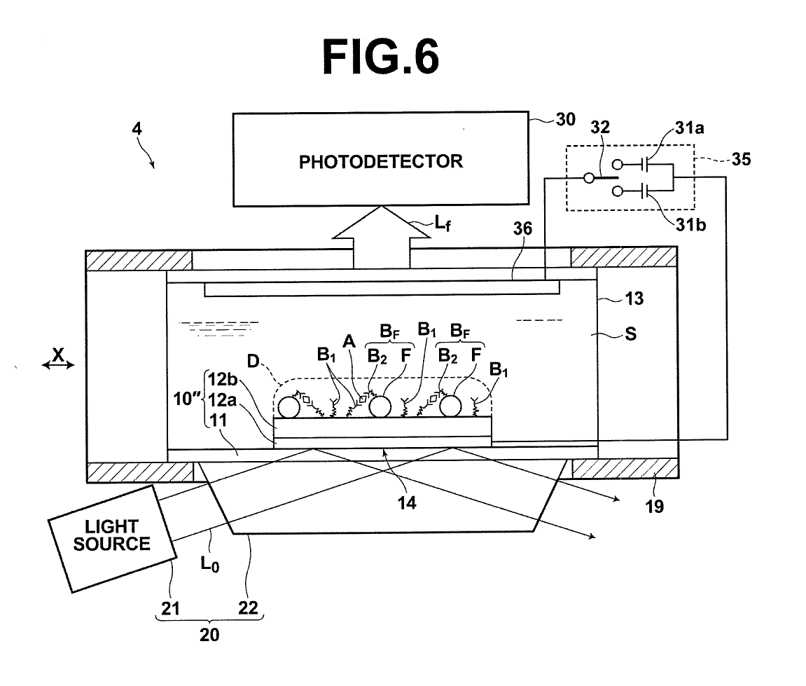

A detection method and apparatus according to a fourth embodiment will be described with reference to FIG. 6. FIG. 6 is a schematic diagram illustrating the structure of the whole detection apparatus of the fourth embodiment. The detection method and apparatus in this embodiment uses a sensor chip including an optical waveguide layer on the metal layer, and excites an optical waveguide mode in the optical waveguide layer by irradiation with excitation light. Further, an optical field is enhanced by the optical waveguide mode, and fluorescence is excited in the enhanced optical field to detect the fluorescence.

The structure of the fluorescence detection apparatus 4 illustrated in FIG. 6 is the same as the structure of the fluorescence detection apparatus of the first embodiment. However, the sensor chip used in the present embodiment differs from the sensor chip used in the first embodiment. The mechanism of enhancing the optical field in the present embodiment differs because of the difference in the sensor chip.

A sensor chip 10″ includes an optical waveguide layer 12b on the metal layer 12a. The thickness of the optical waveguide layer 12b is not particularly limited. The thickness of the optical waveguide layer 12b may be determined so that the optical waveguide mode is induced. The thickness is determined by considering the wavelength of the excitation light L₀, the incident angle of the excitation light L₀, the refractive index of the optical waveguide layer 12b, and the like. For example, when a laser beam that has a center wavelength of 780 nm is used as the excitation light L₀ in a manner similar to the aforementioned example, and the optical waveguide layer 12b made of a single layer of silicon oxide film is used, it is desirable that the thickness of the optical waveguide layer 12b is approximately in the range of 500 to 600 nm. Further, the optical waveguide layer 12b may have layered structure including at least a layer of internal optical waveguide layer made of an optical waveguide material, such as a dielectric. It is desirable that the layered structure is an alternately-layered structure in which an internal optical guide layer and an internal metal layer are sequentially deposited from the metal layer side.

A fluorescence detection method according to the present embodiment using the fluorescence detection apparatus 4 will be described.

With the sensor chip 10″ set in the housing unit 19, the switch of the voltage application means 35 is connected to the first power source, and voltage is applied between electrodes by using the metal layer 12 side as the positive electrode. Accordingly, the negatively electrified fluorescent substance F of the fluorescent-label binding substance B_{F} that has bound to the sensor portion is attracted to the sensor portion 14. In this state, in which the fluorescent substance F is attracted to the sensor portion 14, excitation light L₀ is output from the excitation light irradiation optical system 20 in a manner similar to the first embodiment. The excitation light irradiation optical system 20 outputs the excitation light L₀ in such a manner that the excitation light L₀ enters the interface between the dielectric plate 11 and the metal layer 12 at a specific incident angle that is greater than or equal to a total reflection angle. When the light L₀ enters the interface in such a manner, evanescent waves extend to the optical waveguide layer 12b on the metal layer 12, and the evanescent waves couple to the optical waveguide mode of the optical waveguide layer 12b. Accordingly, an optical waveguide mode is excited. Further, the optical field (an electric field induced by evanescent waves) that has been generated on the metal layer by the incident excitation light is enhanced by the optical waveguide mode. Accordingly, optical field enhanced region D is formed on the optical waveguide layer. Since the electrified fluorescent substance F has been attracted to the surface of the metal layer in the optical field enhanced region D by application of voltage by the voltage application means 35, the fluorescent substance F is excited (fluorescent dye molecules f in the fluorescent substance are substantially excited), and fluorescence L_{f} is output. The fluorescence is enhanced by the optical field enhancement effect by the optical waveguide mode. The fluorescence L_{f} is detected by the photodetector 30. Accordingly, it is possible to detect the presence and/or amount of the detection target substance that has bound to the fluorescent-label binding substance.

In the present embodiment, the fluorescent-label binding substance includes electrified fluorescent substance, and fluorescence is generated in a state in which the fluorescent substance is attracted to the sensor portion. Further, radiation light induced by the enhanced fluorescence is detected. Therefore, it is possible to achieve an advantageous effect similar to the first embodiment.

Further, in the distribution of optical field enhanced by excitation of the optical waveguide mode, the degree of attenuation of the electric field according to the distance from the surface is small, compared with the degree of attenuation in the distribution of optical field generated by surface plasmons. Therefore, when a fluorescent substance that has a large diameter, and which includes a plurality of fluorescent dye molecules, is used as the fluorescent label, a greater fluorescent amount increase effect is achieved in enhancement of the optical field by the optical waveguide mode, compared with enhancement of the optical field by surface plasmons.

### Fifth Embodiment

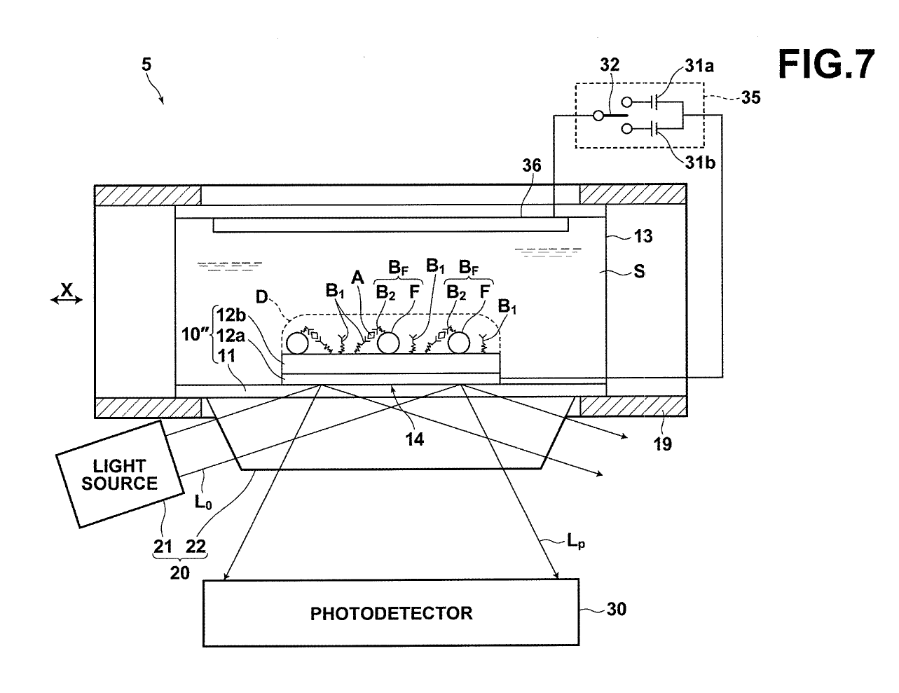

A detection method and apparatus according to a fifth embodiment will be described with reference to FIG. 7. FIG. 7 is a schematic diagram illustrating the structure of the whole detection apparatus of the fifth embodiment. The detection method and apparatus of this embodiment uses a sensor chip including an optical waveguide layer on the metal layer, and excites an optical waveguide mode in the optical waveguide layer by irradiation with excitation light. Further, an optical field is enhanced by the optical waveguide mode, and fluorescence excited in the enhanced optical field newly induces plasmons in the metal layer. Further, light from the newly-induced plasmons radiates from the opposite surface of the dielectric plate, the opposite surface being opposite to the metal-layer-formation surface of the dielectric plate. Further, radiation light from the newly induced plasmons is detected in the radiation light detection method and apparatus of this embodiment.

The structure of the radiation light detection apparatus 5 illustrated in FIG. 7 is similar to the radiation light detection apparatus of the third embodiment. The sensor chip used in the detection method of the present embodiment is similar to the sensor chip used in the fluorescence detection method of the fourth embodiment.

A radiation detection method according to the present embodiment using the radiation light detection apparatus 5 will be described.

With the sensor chip 10″ set in the housing unit 19, the switch of the voltage application means 35 is connected to the first power source, and voltage is applied between electrodes by using the metal layer 12 side as the positive electrode. Accordingly, the negatively electrified fluorescent substance F of the fluorescent-label binding substance B_{F} that has bound to the sensor portion 14 is attracted to the sensor portion 14. In this state, in which the fluorescent substance F is attracted to the sensor portion 14, excitation light L₀ is output from the excitation light irradiation optical system 20 in a manner similar to the first embodiment. The excitation light irradiation optical system 20 outputs the excitation light L₀ in such a manner that the excitation light L₀ enters the interface between the dielectric plate 11 and the metal layer 12 at a specific incident angle that is greater than or equal to a total reflection angle. When the light L₀ enters the interface in such a manner, evanescent waves extend to the optical guide layer 12b on the metal layer 12, and the evanescent waves couple to the optical waveguide mode of the optical waveguide layer 12b. Accordingly, an optical waveguide mode is excited. Further, the optical field (an electric field induced by evanescent waves) that has been generated on the optical waveguide layer by the incident excitation light is enhanced by the optical waveguide mode. Accordingly, optical field enhanced region D is formed on the optical waveguide layer. Since the electrified fluorescent substance F has been attracted to the surface of the metal layer in the optical field enhanced region D by application of voltage by the voltage application means 35, the fluorescent substance F is excited (fluorescent dye molecules f in the fluorescent substance are substantially excited), and fluorescence L_{f} is output. The fluorescence is enhanced by the optical field enhancement effect by the optical waveguide mode. The fluorescence L_{f} generated on the optical waveguide layer 12b newly induces surface plasmons in the metal film 12, and radiation light Lₚ is output by the surface plasmons at a specific angle from an opposite surface of the sensor chip 10, the opposite surface being opposite to the metal film formation surface. Further, the radiation light Lₚ is detected by the photodetector 30. Accordingly, it is possible to detect the presence and/or amount of the detection target substance labeled with the fluorescent label F.

In the present embodiment, the fluorescent-label binding substance includes electrified fluorescent substance, and fluorescence is generated in a state in which the fluorescent substance is attracted to the sensor portion. Further, radiation light induced by the enhanced fluorescence is detected. Therefore, it is possible to achieve an advantageous effect similar to the first embodiment.

Further, in the present embodiment, light induced by the fluorescence generated on the surface (front surface) of the sensor is detected from the back side of the sensor. Therefore, it is possible to reduce the distance of a solvent through which the fluorescence L_{f} passes, and which greatly absorbs light, to approximately several tens nm. Hence, it is possible to achieve an effect similar to the second embodiment.

Further, since the electric field enhancement by excitation of the optical waveguide mode is used, it is possible to achieve a fluorescent amount increase effect similar to the fourth embodiment.

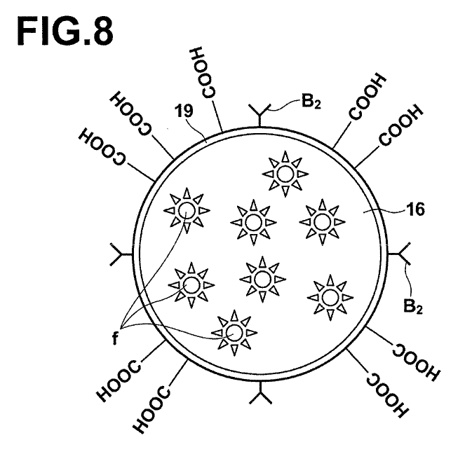

As illustrated in FIG. 8, a metal coating 19 may be further provided on the surface of the material 16. The thickness of the metal coating 19 should be sufficiently thin to transmit fluorescence. The metal coating 19 may be provided on the entire surface of the material 16. Alternatively, the metal coating 19 may be provided in such a manner that a part of the surface of the material 16 is exposed. As the material of the metal coating 19, a metal material similar to the aforementioned material of the metal layer may be used.

When the metal coating 19 is provided on the surface of the fluorescent substance, the surface plasmons or localized plasmons generated in the metal layers 12, 12′ of the sensor chips 10, 10′ couple to a whispering gallery mode of the metal coating 19 of the fluorescent substance F. Therefore, it is possible to more efficiently excite the fluorescent dye molecules f in the fluorescent substance F. The whispering gallery mode is an electromagnetic wave mode that is localized on the spherical surface of a micro-sphere of approximately ø5300 nm or less, such as the fluorescent substance used here, and that travels around the spherical surface of the micro-sphere.

An example of a method for applying the metal coating to the fluorescent substance will be described.

First, a fluorescent substance is produced through the aforementioned procedure. Further, the surface of the fluorescent substance is modified with polyethyleneimine (PEI) (EPOMIN, produced by NIPPON SHOKUBAI CO., LTD).

Next, Pd nano particles having a diameter of 15 nm (average particle diameter of 15 nm, produced by TOKURIKI-HONTEN) is adsorbed by the PEI on the surface of the particle.

The polystyrene particle that has adsorbed the Pd nano particles is impregnated in electroless gold plating solution (HAuCl₄, produced by Kojima Chemicals, Co., LTD.). Accordingly, a gold coating is deposited on the surface of the polystyrene particle by electroless plating using Pd nano particles as a catalyst.

### “Sample Cell for Detection”

A sample cell for detection that is used as a sensor chip in the detection method of the present invention will be described.

### <Sample Cell of First Embodiment>

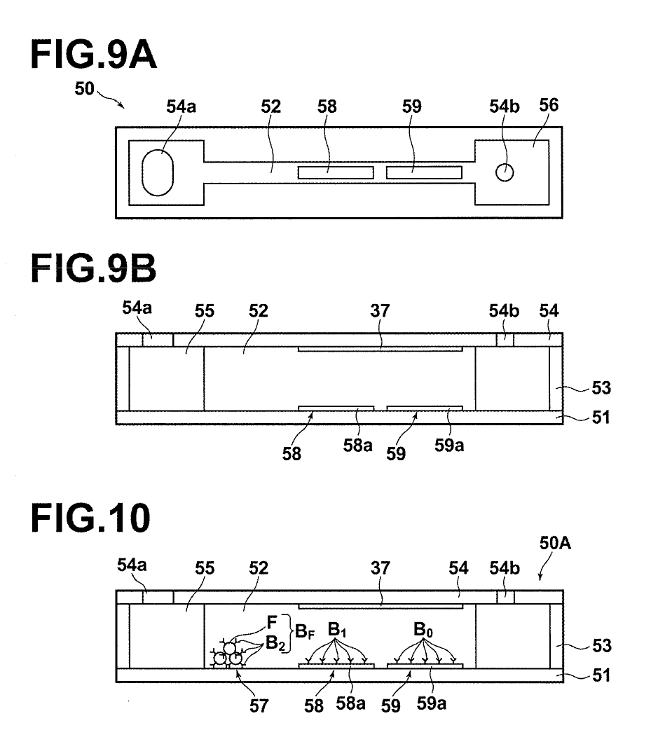

FIG. 9A is a plan view illustrating the structure of a sample cell 50 according to a first embodiment. FIG. 9B is a sectional side view of the sample cell 50.

The sample cell 50 for detection includes a base (substrate) 51, a spacer 53, and an upper plate 54. The base 51 is formed by a dielectric plate. The spacer 53 retains liquid sample S on the base 51, and forms a flow path 52 of the liquid sample S. The upper plate 54 is formed by a glass plate that has an injection opening 54a for injecting the sample S and an air hole 54b for discharging the sample that has flowed through the flow path 52. Further, sensor portions 58, 59 formed by metal layers 58a, 59a are provided in predetermined areas on the sample-contact surface of the base 51. The sensor portions 58, 59 are provided between the injection opening 54a and the air hole 54b of the flow path 52. Further, a membrane filter 55 is provided in a portion of the sample cell 50 from the injection opening 54 to the flow path 52. Further, a waste liquid reservoir 56 is provided on the downstream side of the flow path 52. The waste liquid reservoir 56 is connected to the air hole 54b. Further, a transparent electrode 37, as a counter-electrode, is provided at a portion of the sample-contact surface of the upper plate 54, the portion facing the sensor portions 58 and 59.

In the present embodiment, the base 51 is formed by the dielectric plate, and the base 51 also functions as the dielectric plate of the sensor portion. Alternatively, only a part of the base, the part constituting the sensor portions, may be formed by the dielectric plate.

The sample cell 50 may be used as a sensor chip in any of the detection apparatuses and method in the first through fifth embodiments in a similar manner. Further, application of voltage to the sample is performed by connecting the transparent electrode 37 and the metal layer provided in the sensor portion to the voltage application means 35 to apply voltage between the transparent electrode and the metal layer.

The sample cell 50 for detection of the present invention may be used by appropriately immobilizing, based on the detection target substance, a first binding substance that specifically binds to the detection target substance in the sensor portion.

Further, the sample cell 50 for detection may be used by appropriately immobilizing a fluorescent-label binding substance at a position that is on the upstream side of the sensor portions in the flow path. The fluorescent-label binding substance includes one of a second binding substance that specifically binds to the detection target substance and a third binding substance that competes with the detection target substance and specifically binds to the first binding substance and a fluorescent substance the surface of which is modified with the one of the second binding substance and the third binding substance and with a functional group that exhibits a polarity at least in the liquid sample.

<Sample Cell according to Second Embodiment>

FIG. 10 is a sectional side view illustrating a sample cell of the second embodiment that is suitable for an assay by a sandwich method. In a sample cell 50A of the present embodiment, a labeling secondary antibody adsorption area 57, a first measurement area 58, and a second measurement area 59 are sequentially formed on the base 51 from the upstream side of the flow path 52. In the labeling secondary antibody adsorption area 57, a fluorescent-label binding substance B_{F} (hereinafter, referred to as “labeling secondary antibody B_{F}”) has been physically adsorbed. The fluorescent-label binding substance B_{F} contains the secondary antibody (second binding substance) B₂ that specifically binds to the antigen, which is the detection target substance, and fluorescent substance F, the surface of which is modified with the secondary antibody B₂ and a functional group (for example, —COOH, —NH₂ or the like, which is not illustrated) that exhibits a polarity in a liquid sample. In the first measurement area 58, a primary antibody (first binding substance) B₁ is immobilized. The primary antibody B₁ specifically binds to the antigen, which is the detection target substance. In the second measurement area 59, a primary antibody B₀ is immobilized. The primary antibody B₀ does not bind to the antigen A, which is the detection target substance, but specifically binds to the secondary antibody B₂. The first measurement area 58 and the second measurement area 59 correspond to the sensor portion. In this example, two measurement areas are provided in the sensor portion. Alternatively, only one measurement area may be provided.

In the first measurement area 58, a gold (Au) layer 58a, as a metal layer, is formed on the base 51. In the second measurement area 59, a gold (Au) layer 59a, as a metal layer, is formed on the base 51. Further, primary antibody B₁ is immobilized on the Au layer 58a of the first measurement area 58, and primary antibody B₀, which is different from the primary antibody B₁, is immobilized on the Au layer 59a of the second measurement area 59. The first measurement area 58 and the second measurement area 59 are structured in the same manner except that the immobilized primary antibodies differ from each other. The primary antibody B₀, which is immobilized in the second measurement area 59, does not bind to antigen A, but directly binds to secondary antibody B₂. Accordingly, it is possible to detect fluctuation factors related to reaction, such as the amount or activity of the labeling secondary antibody B_{F} that has flowed through the flow path. Further, it is possible to detect fluctuation factors related to the degree of enhancement of the optical field, such as the excitation light irradiation optical system 20, the gold (Au) layers 58a, 59a, and the liquid sample S. Further, the detected fluctuation factors can be used for calibration. It is not necessary that the primary antibody B₀ is immobilized in the second measurement area 59. Instead of the primary antibody B₀, a known amount of labeling substance may be immobilized in the second measurement area 59 in advance. The labeling substance may be the same kind of substance as the fluorescent substance F of the labeling secondary antibody B_{F}. Alternatively, the labeling substance may be a fluorescent substance that has a different wavelength and size from the fluorescent substance F of the labeling secondary antibody B_{F}. Further, the labeling substance may be a metal microparticle or the like. In this case, only the fluctuation factors related to the degree of enhancement of optical field, such as the excitation light irradiation optical system 20, the gold (Au) layers 58a, 59a, and the liquid sample S, may be detected to use the detected factors for calibration. Whether the labeling secondary antibody B_{F} or the known amount of labeling substance that is different from the labeling secondary antibody B_{F} is immobilized in the second measurement area 59 should be appropriately determined based on the purpose and method of calibration.

The sample cell 50A may be used instead of the sensor chip in any of the detection apparatuses and methods of the first through fifth embodiments in a similar manner. In the housing unit 19, the sample cell 50A can move in X direction relative to the excitation light irradiation optical system 20 and the photodetector 30. After fluorescence or radiation light from the first measurement area 58 is detected and measured, the second measurement area 59 is moved to the detection position, and fluorescence or radiation light from the second measurement area 59 is detected.

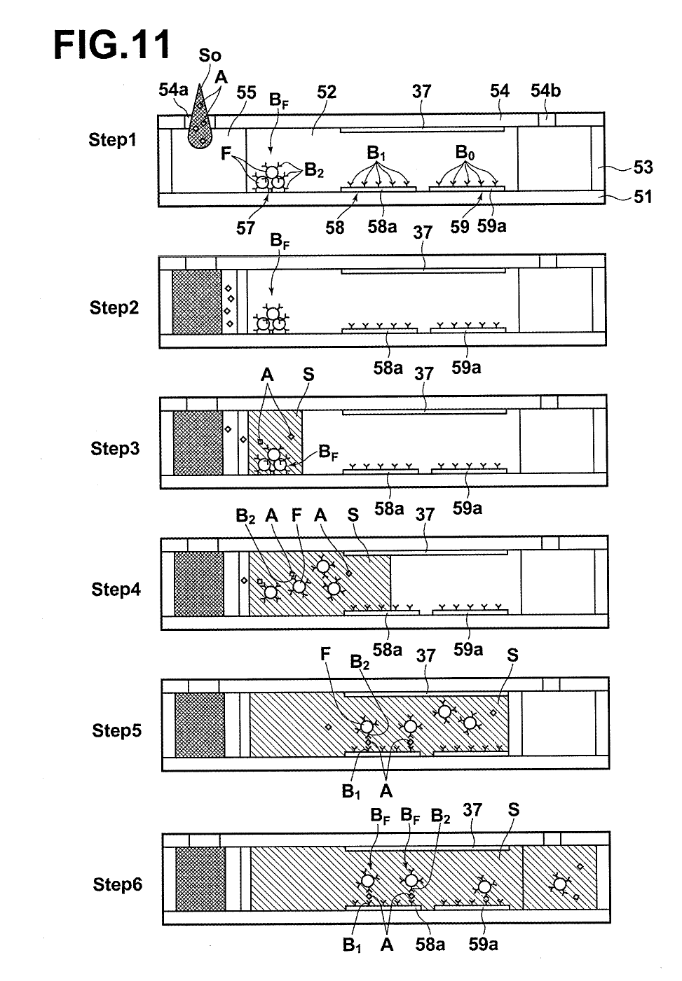

With reference to FIG. 11, assay procedures by using a sandwich method will be described. In the assay procedures, whether blood (whole blood) contains an antigen, which is a detection target substance, is detected by using the sample cell 50A of the present embodiment.

Step 1: Blood (whole blood) Sₒ, which is the assay target (examination target), is injected from the injection opening 54a. Here, a case in which the antigen that is the detection target substance is included in the blood Sₒ will be described. In FIG. 11, the whole blood Sₒ is indicated by a mesh.

Step 2: The whole blood Sₒ is filtered by the membrane filter 55, and large molecules, such as erythrocyte (red blood cells) and leukocyte (white blood cells), remain as a residue.

Step 3: Blood (plasma, blood plasma) S after blood cells (blood corpuscles) are removed by the membrane filter 55 penetrates into the flow path 52 by a capillary action. Alternatively, a pump may be connected to the air hole 54b to accelerate reaction, thereby reducing detection time. The pump sucks the blood after blood cells are removed by the membrane filter 55 and pumps (pressures to discharge) the sucked blood, thereby causing the blood to flow down through the path. In FIG. 11, the blood plasma S is indicated by a shadow.

Step 4: The blood plasma S that has penetrated into the flow path 52 and the labeling secondary antibody B_{F} are mixed together. Accordingly, antigen A in the blood plasma and the secondary antibody B₂ of labeling secondary antibody B_{F} bind to each other.

Step 5: The blood plasma S gradually flows down to the air hole 54b side along the flow path 52. The antigen A that has bound to the secondary antibody B₂ binds to the primary antibody B₁ that has been immobilized in the first measurement area 58. Accordingly, a so-called sandwich is formed, in which the antigen A is sandwiched between the primary antibody B₁ and the secondary antibody B₂ (labeling secondary antibody B_{F}).

Step 6: A part of the labeling secondary antibody B_{F} that has not bound to the antigen A binds to the primary antibody B₀ immobilized on the second measurement area 59. Further, even if the labeling secondary antibody B_{F} that has bound neither to the antigen A nor to the primary antibody B₀ remains in the measurement areas, the blood plasma flowing next functions as washing liquid, and washes away floating or non-specifically-adsorbed labeling secondary antibody.

As described above, in Steps 1 through 6, the blood is injected from the injection opening and a sandwich in which the antigen A is sandwiched between the primary antibody B₁ and the labeling secondary antibody B_{F} is formed on the measurement area 58. After Steps 1 through 6, in the detection apparatus, the voltage application means applies voltage to attract fluorescent substance F onto the sensor portion, and the intensity of fluorescence or radiation light (hereinafter, referred to as “signal”) from the first measurement area 58 is detected. After then, the sample cell 50 is moved in X direction so that the signal from the second measurement area 59 can be detected, and the signal from the second measurement area 59 is detected. The signal from the second measurement area 59 in which the primary antibody B₀ that binds to the labeling secondary antibody B_{F} is immobilized reflects reaction conditions, such as the amount and the activity of the labeling secondary antibody that has flowed down. Therefore, if this signal is used as a reference (reference signal) and the signal from the first measurement area is corrected based on the reference, it is possible to obtain a more accurate detection result (presence of the antigen and/or the concentration thereof). Further, even when a known amount of labeling substance (fluorescence substance or metal microparticle) is immobilized in advance in the second measurement area 59, as described above already, it is possible to use the signal from the second measurement area 59 as a reference in a similar manner, and the signal from the first measurement area can be corrected based on the reference.

<Sample Cell according to Third Embodiment>

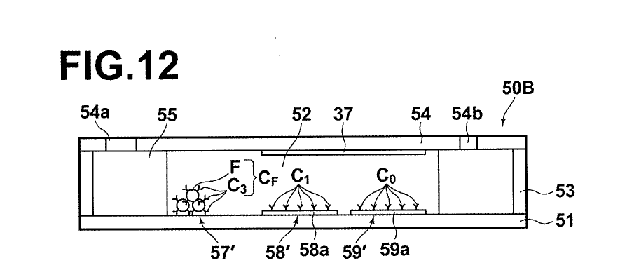

FIG. 12 is a sectional side view of a sample cell of the third embodiment that is suitable for an assay by a competition method. In a sample cell 50B of the present embodiment, a labeling secondary antibody adsorption area 57′, a first measurement area 58′, and a second measurement area 59′ are sequentially formed on the base 51 of the sample cell 50B from the upstream side of the flow path 52. In the labeling secondary antibody adsorption area 57′, a fluorescent-label binding substance C_{F} (hereinafter, referred to as “labeling secondary antibody C_{F}”) has been physically adsorbed. The fluorescent-label binding substance C_{F} contains the secondary antibody (third binding substance) C₃ that does not bind to the antigen A, which is the detection target substance, and that specifically binds to the primary antibody, which will be described later, and fluorescent substance the surface of which is modified with the secondary antibody C₃ and a functional group (for example, —COOH, —NH₂ or the like, which is not illustrated) that exhibits a polarity in a liquid sample. In the first measurement area 58′, a primary antibody (first binding substance) C₁ are immobilized. The primary antibody C₁ specifically binds to the antigen A, which is the detection target substance, and the secondary antibody C₃. In the second measurement area 59′, a primary antibody C₀ is immobilized. The primary antibody C₀ does not bind to the antigen A, which is the detection target substance, but specifically binds to the secondary antibody C₃ of the labeling secondary antibody C_{F}.

In the first measurement area 58′, a gold (Au) layer 58a, as a metal layer, is formed on the base 51. In the second measurement area 59′, a gold (Au) layer 59a, as a metal layer, is formed on the base 51. Further, primary antibody C₁ is immobilized on the Au layer 58a of the first measurement area 58′, and primary antibody C₀, which is different from the primary antibody C₁, is immobilized on the Au layer 59a of the second measurement area 59′. The first measurement area 58′ and the second measurement area 59′ are structured in the same manner except that the immobilized primary antibodies differ from each other. The antigen A and the secondary antibody C₃ compete with each other and bind to the primary antibody C₁ that is immobilized in the first measurement area 58′. The primary antibody C₀ immobilized in the second measurement area 59′ does not bind to antigen A, but directly binds to secondary antibody C_{F}. Accordingly, it is possible to detect fluctuation factors related to reaction, such as the amount and activity of the labeling secondary antibody that has flowed through the flow path. Further, it is possible to detect fluctuation factors related to the degree of enhancement of the optical field, such as the excitation light irradiation optical system 20, the gold (Au) layers 58a, 59a, and the liquid sample S. Further, the detected fluctuation factors can be used for calibration. It is not necessary that the primary antibody C₀ is immobilized in the second measurement area 59′. Instead of the primary antibody C₀, a known amount of labeling substance may be immobilized in the second measurement area 59′ in advance. The labeling substance may be the same kind of substance as the fluorescent substance F of the labeling secondary antibody C_{F}. Alternatively, the labeling substance may be a fluorescent substance that has a different wavelength and size from the fluorescent substance F of the labeling secondary antibody C_{F}. Alternatively, the labeling substance may be a metal microparticle or the like. In this case, only the fluctuation factors related to the degree of enhancement of the optical field, such as the excitation light irradiation optical system 20, the gold (Au) layers 58a, 59a, and the liquid sample S, may be detected to be used for calibration. Whether the labeling secondary antibody C_{F} or the known amount of labeling substance, which is different from the labeling secondary antibody C_{F}, is immobilized in the second measurement area 59′ may be appropriately determined based on the purpose and method of calibration.

The sample cell 50B may be used instead of the sensor chip in any of the detection apparatuses and methods of the first through fifth embodiments in a manner similar to the sample cell 50A.

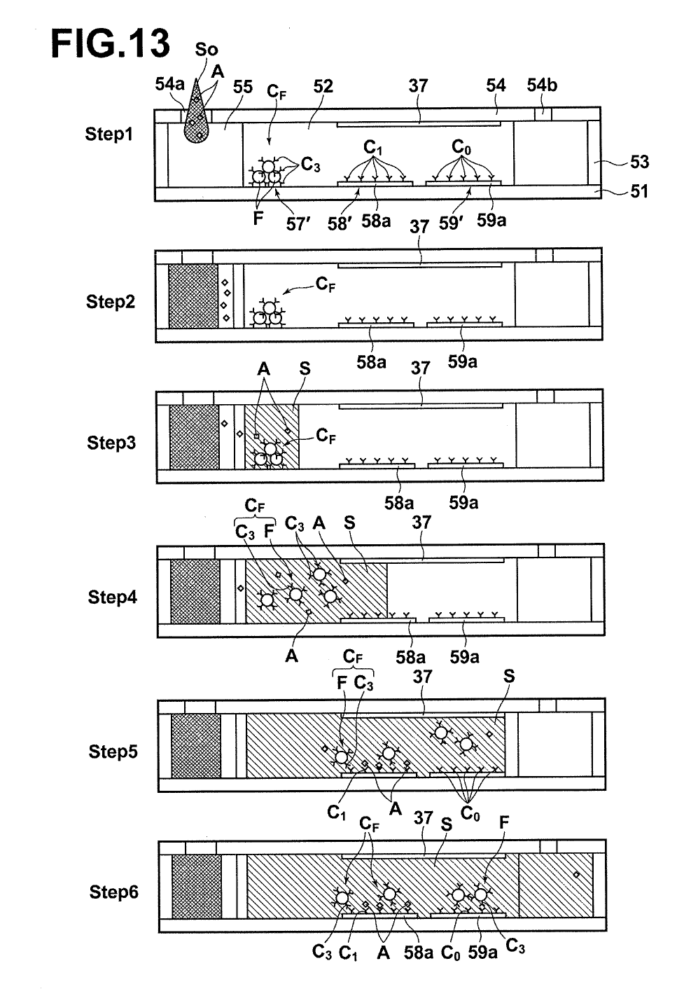

With reference to FIG. 13, assay procedures by using a sandwich method will be described. In the assay procedures, the sample cell 50B for detection of the present embodiment is used, and an assay is performed as to whether an antigen, which is a detection target substance, is included in the blood (whole blood).

Step 1: Blood (whole blood) Sₒ, which is the assay target, is injected from an injection opening 54a. Here, a case in which an antigen that is the detection target substance is included in the blood Sₒ will be described. In FIG. 13, the whole blood Sₒ is indicated by a mesh.

Step 2: The whole blood Sₒ is filtered by a membrane filter 55, and large molecules, such as erythrocyte (red blood cells) and leukocyte (white blood cells), remain as the residue.

Step 3: The blood (plasma, blood plasma) S after blood cells are removed by the membrane filter 55 penetrates into the flow path 52 by a capillary action. Alternatively, a pump may be connected to the air hole 54b to accelerate reaction, thereby reducing detection time. The pump sucks the blood after blood cells are removed by the membrane filter 55 and pumps the sucked blood, thereby causing the blood to flow down through the path. In FIG. 13, the blood plasma S is indicated by a shadow.

Step 4: The blood plasma S that has penetrated into the flow path 52 and the labeling secondary antibody C_{F} are mixed together.

Step 5: The blood plasma S gradually flows to the air hole 54b side along the flow path 52. The antigen A and the secondary antibody C₃ of the labeling secondary antibody C_{F} competitively bind to the primary antibody C₁ that has been immobilized on the first measurement area 58′.

Step 6: A part of the fluorescence labeling secondary antibody C_{F} that has not bound to the primary antibody C₁ on the first measurement area 58′ binds to the primary antibody C₀ immobilized on the second measurement area 59′. Further, even if the labeling secondary antibody C_{F} that has bound neither to the primary antibody C₁ nor to the primary antibody C₀ remains on the measurement areas, the blood plasma S flowing next functions as washing liquid, and washes away a floating or non-specifically-adsorbed labeling secondary antibody C_{F}.

As described above, in Steps 1 through 6, the blood is injected from the injection opening and the antigen A and the secondary antibody C₃ competitively bind to the primary antibody C₁ on the first measurement area 58′. After Steps 1 through 6, in the detection apparatus, the voltage application means applies voltage to attract fluorescent substance F onto the sensor portion, and signals, such as the intensity of the fluorescence or radiation light, from the first measurement area 58′ are detected. Then, the sample cell 50B is moved in X direction so that the signal from the second measurement area 59′ can be detected, and the signal from the second measurement area 59′ is detected. The signal from the second measurement area 59′ is used as reference, and the signal from the first measurement area is corrected. Hence, it is possible to obtain an accurate measurement result (presence of antigen and/or the concentration thereof).

In the competition method, when the concentration of the detection target substance A is higher, the amount of the third bonding substance C₃ that binds to the first binding substance C₁ decreases. Specifically, since the number of particles of the fluorescent substance F on the metal layer becomes smaller, the intensity of fluorescence becomes lower. In contrast, when the concentration of the detection target substance A is lower, the amount of the third bonding substance C₃ that binds to the first binding substance C₁ increases. Specifically, since the number of particles of the fluorescent substance F on the metal layer becomes larger, the intensity of fluorescence becomes higher. In the competition method, measurement is possible if at least one epitope is present in the detection target substance. Therefore, the competition method is suitable to detect a substance that has low molecular weight.

### DESIGN MODIFICATION EXAMPLE OF SAMPLE CELL

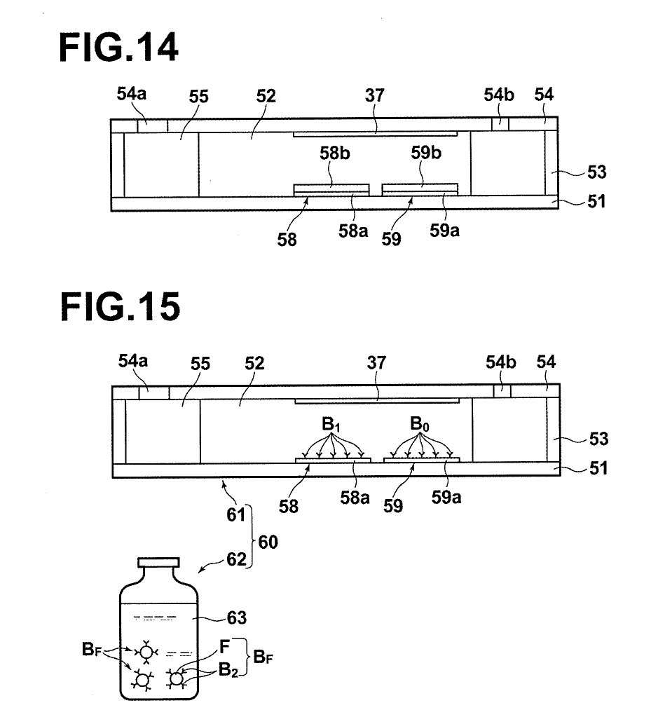

FIG. 14 is a diagram illustrating a sectional view of a sample cell used in the detection method and apparatus using optical field enhancement by an optical waveguide mode. The structure of the sample cell illustrated in FIG. 14 is substantially the same as the structure of the sample cell of the first embodiment, illustrated in FIG. 9. However, in FIG. 15, optical waveguide layers 58b, 59b are further provided on the metal layers 58a, 59a in the sensor portion.

This sample cell may be used by appropriately immobilizing a first binding substance in the sensor portion and a fluorescent-label binding substance on the upstream side of the sensor portion.

### “Kit for Detection”

A kit for detection used in the detection method of the present invention will be described.

FIG. 15 is a schematic diagram illustrating the structure of a kit 60 for detecting fluorescence.

The kit 60 for detection includes a sample cell 61 and a solution 63 for labeling, which is injected into the flow path of the sample cell 61 together with the liquid sample or after the liquid sample flows down to perform fluorescence detection measurement. The solution 63 for labeling contains fluorescent-label binding substance B_{F} (hereinafter, referred to as “labeling secondary antibody B_{F}”) containing secondary antibody (second binding substance) B₂ that specifically binds to the antigen A and fluorescent substance F the surface of which has been modified with the secondary antibody B₂ and a functional group (for example, —COOH, —NH₂ or the like, which is not illustrated) that exhibits a polarity in the liquid sample. In the solution for labeling, the functional group is ionized. Consequently, the fluorescent substance is electrified.

The sample cell 61 differs from the sample cell 50A of the second embodiment only in that a physical adsorption area, in which fluorescent-label binding substance B_{F} is physically adsorbed, is not provided in the sample cell 61. The remaining structure of the sample cell 61 is substantially the same as the structure of the sample cell 50A of the second embodiment.

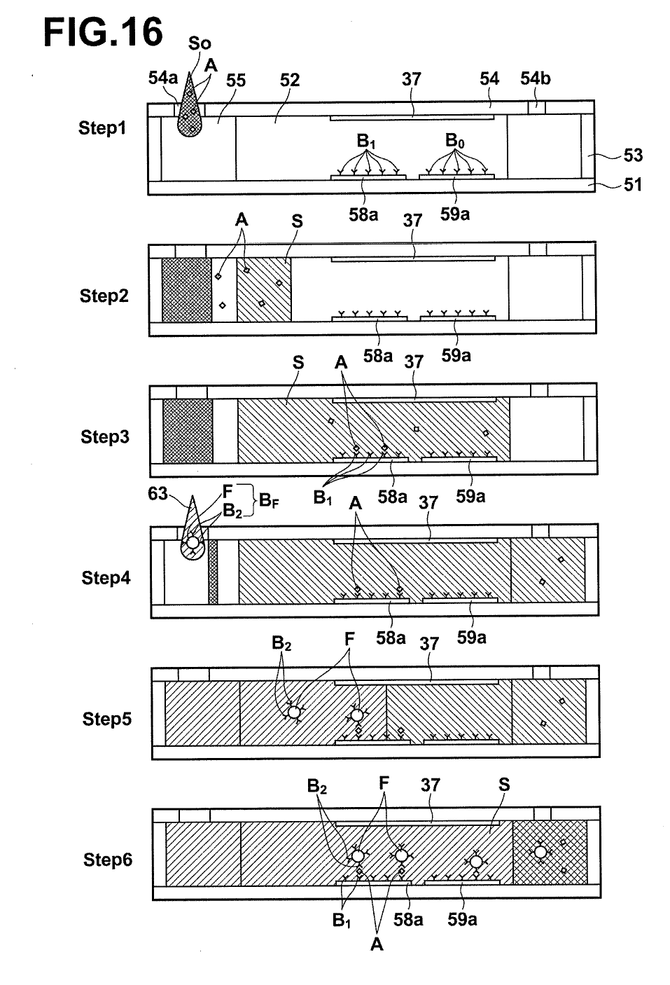

With reference to FIG. 16, assay procedures in the detection method of the present invention by using a sandwich method will be described. In the assay procedures, the kit 60 for detection of the present embodiment is used, and an assay is performed as to whether the blood (whole blood) contains an antigen, which is the detection target substance.

Step 1: Blood (whole blood) Sₒ, which is the assay target, is injected from an injection opening 54a. Here, a case in which the antigen that is the substance to be detected is contained in the blood Sₒ will be described. In FIG. 16, the whole blood Sₒ is indicated by a mesh.

Step 2: The whole blood Sₒ is filtered by the membrane filter 55, and large molecules, such as erythrocyte (red blood cells) and leukocyte (white blood cells), remain as a residue. Then, the blood (plasma, blood plasma) S after blood cells are removed by the membrane filter 55 penetrates into the flow path 52 by a capillary action. Alternatively, a pump may be connected to the air hole to accelerate reaction, thereby reducing detection time. The pump sucks the blood after blood cells are removed by the membrane filter 55 and pumps the sucked blood, thereby causing the blood to flow down through the path. In FIG. 16, the blood plasma S is indicated by a shadow.

Step 3: The blood plasma S gradually flows to the air hole 54b side along the flow path 52. The antigen A in the blood plasma S binds to the primary antibody B₁ that has been immobilized in the first measurement area 58.

Step 4: a solution 63 for labeling is injected from the injection opening 54a. The solution 63 for labeling contains electrified labeling secondary antibody B_{F}.

Step 5: the labeling secondary antibody B_{F} penetrates into the flow path 52 by a capillary action. Alternatively, a pump may be connected to the air hole to accelerate reaction, thereby reducing detection time. The pump sucks the blood after blood cells are removed by the membrane filter 55 and pumps the sucked blood, thereby causing the blood to flow down through the path.

Step 6: The labeling secondary antibody B_{F} gradually flows down to the downstream side, and the secondary antibody B₂ of the labeling secondary antibody B_{F} binds to the antigen A. Consequently, a so-called sandwich in which the antigen A is sandwiched between the primary antibody B₁ and the secondary antibody B₂ is formed. Further, a part of the secondary antibody B₂ that has not bound to the antigen A binds to the primary antibody B₀ immobilized on the second measurement area 59. Further, even if the labeling secondary antibody B_{F} that has bound neither to the antigen A nor to the primary antibody B₀ remains in the measurement areas, the blood plasma S flowing next functions as washing liquid, and washes away floating or non-specifically-adsorbed labeling secondary antibody on the plate.

As described above, in Steps 1 through 6, the blood is injected from the injection opening and the antigen binds to the primary antibody and the secondary antibody. After Steps 1 through 6, in the detection apparatus, voltage is applied by a voltage application means to attract the fluorescent substance F onto the sensor portion, and a signal from the first measurement area 58 is detected. After then, the sample cell 61 is moved in X direction so that the signal from the second measurement area 59 can be detected. The fluorescent-label binding substance is attracted onto the sensor portion in a similar manner, and the signal from the second measurement area 59 is detected. The signal from the second measurement area 59 in which the primary antibody B₀ that binds to the secondary antibody B₂ of the labeling secondary antibody B_{F} is immobilized reflects reaction conditions, such as the amount and activity of the labeling secondary antibody that has flowed down. Therefore, if this signal is used as a reference (reference signal) and the signal from the first measurement area is corrected based on the reference, it is possible to obtain a more accurate detection result (presence of antigen and/or the concentration thereof). Further, a known amount of labeling substance (fluorescent substance or metal microparticle) may be immobilized in advance in the second measurement area 59, and the fluorescence signal from the second measurement area 59 may be used as a reference to correct the signal from the first measurement area 58 based on the reference.

An example of a method for modifying the fluorescent substance with the secondary antibody and an example of a method for producing a solution for labeling will be described.

A solution containing 50 mM of MES buffer and an anti-hCG monoclonal antibody of 5.0 mg/mL (Anti-hCG 5008 SP-5, Medix Biochemica) is added to the fluorescent substance solution (diameter of the fluorescent substance is 500 nm, and the excitation wavelength is 780 nm) that has been prepared as described above, and stirred. Accordingly, the fluorescent substance is modified with the antibody.

Further, a WSC aqueous solution of 400 mg/mL (Product No. 01-62-0011, Wako Pure Chemical Industries, Ltd.) is added, and stirred at a room temperature.

Further, a Glycine aqueous solution of 2 mol/L is added, and stirred. Then, particles are precipitated by centrifugation.

Finally, the supernatant is removed, and PBS (pH7.4) is added. An ultrasonic wash machine is used to redisperse the fluorescent substance the surface of which has been modified. Further, centrifugation is performed, and the supernatant is removed. Then, 500 μL of PBS (pH 7.4) solution of 1% BSA is added, and the fluorescent substance F is redispersed to obtain a solution for labeling.

### DESIGN MODIFICATION EXAMPLE OF KIT FOR EXAMINATION

As the sample cell that is used in the detection method and apparatus using the optical field enhancement by an optical waveguide mode, the sample cell as illustrated in FIG. 14 may be used. In the sample cell illustrated in FIG. 14, optical waveguide layers 58b, 59b are further provided on the metal layers 58a, 59a of the sensor portion. Further, the primary antibody B₁ and the primary antibody B₀, which is different from the primary antibody B₁, are immobilized on the optical waveguide layers 58b, 59b, respectively.

Further, when an assay by a competition method is performed, instead of the primary antibody B₁ and the primary antibody B₀, the primary antibody (first binding substance) C₁ that specifically binds to the antigen A, which is the detection target substance, and the secondary antibody C₃, and the primary antibody C₀ that does not bind to the antigen A, which is the detection target substance, but specifically binds to the secondary antibody C₃ are immobilized on the sensor portion in the sample cell. Further, as the solution for labeling, a solution containing the fluorescent-label binding substance C_{F} should be used. The fluorescent-label binding substance C_{F} contains the secondary antibody (third binding substance) C₃ that does not bind to the antigen A, which is the detection target substance, but specifically binds to the primary antibody, and a fluorescent substance, the surface of which is modified with the secondary antibody C₃ and a functional group that exhibits a polarity in the sample liquid.

What is claimed is:

1. A detection method comprising the steps of:
preparing a sensor chip including a sensor portion that has at least a metal layer deposited on a surface of a dielectric plate;
binding a fluorescent-label binding substance in an amount corresponding to the amount of a detection target substance contained in a liquid sample to the sensor portion by contacting the liquid sample with the sensor portion;
irradiating the sensor portion with excitation light to generate an enhanced optical field on the sensor portion; and
detecting the amount of the detection target substance based on the amount of light generated by excitation of a fluorescent label contained in the fluorescent-label binding substance, the fluorescent label being excited in the enhanced optical field, wherein an electrified fluorescent substance containing a plurality of fluorescent dye molecules enclosed by a material that transmits fluorescence output from the plurality of fluorescent dye molecules is used as the fluorescent label, and wherein the electrified fluorescent substance is attracted to the sensor portion by applying voltage to the liquid sample in a state in which the fluorescent-label binding substance has bound to the sensor portion, and wherein the amount of the detection target substance is detected in the state in which the fluorescent substance is attracted to the sensor portion.

2. A detection method, as defined in claim 1, wherein a fluorescent substance the surface of which is modified with a functional group that exhibits a polarity at least in the liquid sample is used as the fluorescent substance in the fluorescent-label binding substance.

3. A detection method, as defined in claim 1, wherein the particle size of the fluorescent substance is greater than or equal to 30 nm.

4. A detection method, as defined in claim 1, wherein a counter-electrode is arranged in contact with the liquid sample, and wherein voltage is applied between the counter-electrode and the metal layer on the dielectric plate to apply the voltage to the liquid sample.

5. A detection method, as defined in claim 1, wherein when the fluorescent-label binding substance binds to the sensor portion, first voltage is applied to the liquid sample to attract the electrified fluorescent substance to the sensor portion, and wherein after at least a part of the fluorescent-label binding substance has bound to the sensor portion, application of the first voltage is stopped and second voltage that generates an electric field opposite to the first voltage is applied to the liquid sample to remove the fluorescent-label binding substance that has not bound to the sensor portion from the liquid sample on the sensor portion, and wherein after the fluorescent-label binding substance that has not bound to the sensor portion is removed, the amount of the detection target substance is detected.

6. A detection method as defined in claim 1, wherein plasmons are excited in the metal layer by irradiation with the excitation light to generate the optical field enhanced by the plasmons, and wherein the amount of the detection target substance is detected by detecting, as the light generated by excitation of the fluorescent label, fluorescence output from the fluorescent label by the excitation of the fluorescent label.

7. A detection method as defined in claim 1, wherein plasmons are excited in the metal layer by irradiation with the excitation light to generate the optical field enhanced by the plasmons, and wherein the amount of the detection target substance is detected by detecting, as the light generated by excitation of the fluorescent label, radiation light that radiates from the other surface of the dielectric plate by newly inducing plasmons in the metal layer by fluorescence output from the fluorescent label by the excitation of the fluorescent label.

8. A detection method, as defined in claim 1, wherein the sensor chip includes an optical waveguide layer deposited on the metal layer, and wherein an optical waveguide mode is excited in the optical waveguide layer by irradiation with the excitation light to generate the optical field enhanced by the optical waveguide mode, and wherein the amount of the detection target substance is detected by detecting, as the light generated by excitation of the fluorescent label, fluorescence output from the fluorescent label by excitation of the fluorescent label.

9. A detection method, as defined in claim 1, wherein the sensor chip includes an optical waveguide layer deposited on the metal layer, and wherein an optical waveguide mode is excited in the optical waveguide layer by irradiation with the excitation light to generate the optical field enhanced by the optical waveguide mode, and wherein the amount of the detection target substance is detected by detecting, as the light generated by excitation of the fluorescent label, radiation light that radiates from the other surface of the dielectric plate, the radiation light radiating by newly inducing plasmons in the metal layer by fluorescence output from the fluorescent label by the excitation of the fluorescent label.

10. A detection apparatus comprising:
a housing unit that houses a sensor chip including a sensor portion that has at least a metal layer deposited on a surface of a dielectric plate;
an excitation-light irradiation optical system that irradiates the sensor portion with excitation light;
a light detection means that detects light generated by excitation of the fluorescent label in an enhanced optical field generated on the sensor portion by irradiation with the excitation light; and
a voltage application means that applies voltage to the liquid sample when the sensor chip is housed in the housing unit.

11. A sample cell for detection comprising:
a base that has a flow path through which a liquid sample flows down;
an injection opening for injecting the liquid sample into the flow path, the injection opening being provided on the upstream side of the flow path;
an air hole for causing the liquid sample that has been injected from the injection opening to flow toward the downstream side of the flow path, the air hole being provided on the downstream side of the flow path; and
a sensor chip portion provided between the injection opening and the air hole in the flow path, wherein the sensor chip portion includes a sensor portion that has at least a metal layer deposited on a sample-contact surface of a dielectric plate that is provided at least as a part of the inner wall of the flow path.

12. A sample cell for detection, as defined in claim 11, wherein the sensor portion includes an immobilization layer that binds to a fluorescent-label binding substance.

13. A sample cell for detection, as defined in claim 12, wherein the fluorescent-label binding substance includes, as a fluorescent label, an electrified fluorescent substance containing a plurality of fluorescent dye molecules enclosed by a material that transmits fluorescence output from the plurality of fluorescent dye molecules, and wherein the fluorescent-label binding substance is immobilized in the flow path on the upstream side of the sensor portion.

14. A sample cell for detection, as defined in claim 11, wherein an optical waveguide layer is provided on the metal layer in the sensor portion.

15. A kit for detection comprising:
a sample cell; and
a solution for labeling,
wherein the sample cell includes:
a base that has a flow path through which a liquid sample flows down;
an injection opening for injecting the liquid sample into the flow path, the injection opening being provided on the upstream side of the flow path;
an air hole for causing the liquid sample that has been injected from the injection opening to flow toward the downstream side of the flow path, the air hole being provided on the downstream side of the flow path;
a sensor chip portion provided between the injection opening and the air hole in the flow path, the sensor chip including at least a metal layer deposited on a sample-contact surface of a dielectric plate that is provided at least as a part of the inner wall of the flow path; and
an immobilization layer that is immobilized on the sensor portion, and that binds to a fluorescent-label binding substance,
and wherein the solution for labeling contains the fluorescent-label binding substance that includes, as a fluorescent label, an electrified fluorescent substance including a plurality of fluorescent dye molecules enclosed by a material that transmits fluorescence output from the plurality of fluorescent dye molecules, and wherein the solution for labeling is injected into the flow path to flow down the flow path together with the liquid sample or after the liquid sample has flowed down the flow path.

16. A kit for detection, as defined in claim 15, wherein an optical waveguide layer is provided on the metal layer in the sensor portion.
